(19) United States
(12) Patent Application Publication
(10) Pub. No.: US 2017/0006316 A1
(43) Pub. Date: Jan. 5, 2017

(54) APPARATUS FOR TRANSMITTING AND RECEIVING SIGNAL AND METHOD FOR TRANSMITTING AND RECEIVING SIGNAL

(71) Applicant: LG ELECTRONICS INC., Seoul (KR)

(72) Inventors: Soojin HWANG, Seoul (KR); Jongyeul SUH, Seoul (KR); Hyunmook OH, Seoul (KR)

(73) Assignee: LG ELECTRONICS INC., Seoul (KR)

(21) Appl. No.: 15/125,816

(22) PCT Filed: Apr. 1, 2015
(86) PCT No.: PCT/KR2015/003257

§ 371 Date: Sep. 13, 2016

Related U.S. Application Data
(60) Provisional application No. 61/973,854, filed on Apr. 2, 2014.

(51) Int. Cl. H04N 21/2362; H04N 21/434; H04N 21/858; H04N 21/2383

(52) U.S. Cl. CPC H04N 21/2362; H04N 21/2383; H04N 21/4347; H04N 21/858; H04N 21/816

(57) ABSTRACT

The present invention relates to an apparatus for transmitting and receiving a signal and a method for transmitting and receiving a signal. The present invention provides a method for transmitting a signal, comprising the steps of: (S110) encoding video service data, the video service data comprising UHD video service data; (S120) generating signaling information, the signaling information comprising service description information describing a service, the service description information comprising a first descriptor including service type information which determines a service type, wherein if the service type has a first coding value, the first coding value indicates that the service is a HEVC digital television service, the service information comprising information about an event related to the service, the event information or the service description information comprising a second descriptor, the second descriptor information comprising video characteristic information of the UHD video service data, the video characteristic information comprising video codec information and frame rate information of the UHD video service data; (S130) multiplexing the signaling information and the UHD video data to a transport stream; (S140) channel coding the transport stream; and (S150) modulating the transport stream and transmitting the modulated stream.

### TECHNICAL FIELD

The present invention relates to a signal transceiving apparatus and a signal transceiving method.

### BACKGROUND ART

Research has been carried out into methods of encoding and decoding ultra-high-definition (UHD) video according to the increase of video signal processing speeds. Research has been carried out into methods of processing HD video as well as UHD video without difficulty even when the UHD video is received using an existing HD receiver.

For example, it is necessary to provide a method of transmitting 4K content through an existing broadcast network due to the appearance of camera devices that are capable of capturing video having a solution of 4K and display devices that are capable of displaying the 4K video. In this case, compatibility between a method of providing a 4K broadcast service and an existing HD broadcast must be considered. To date, however, a method of transmitting 4K content that remains compatible with existing HD broadcasts has not yet been provided.

### DISCLOSURE

### Technical Problem

It is an object of the present invention to provide a signal transceiving apparatus and a signal transceiving method that are compatible with existing HD broadcasts while providing an ultra-high-definition video broadcast service.

It is another object of the present invention to provide a signal transceiving apparatus and a signal transceiving method that are capable of providing an ancillary service necessary for an ultra-high-definition video broadcast service.

It is another object of the present invention to provide a signal transceiving apparatus and a signal transceiving method that are capable of displaying a subtitle suitable for an ultra-high-definition video broadcast service.

It is a further object of the present invention to provide a signal transceiving apparatus and a signal transceiving method that are capable of signaling that a target service is a UHD service and/or a 3DTV service and transceiving link information of the UHD service and the 3DTV service such that a receiver performs switching between the UHD service and the 3DTV service, which are identified.

### Technical Solution

The present invention relates to a signal transceiving apparatus and a signal transceiving method. An embodiment of the present invention provides a signal transmitting method including encoding video service data (S110), wherein the video service data includes UHD video service data, creating signaling information, wherein the signaling information includes service description information describing a service, the service description information includes service type information determining the type of the service, the service type information indicates that the service is an HEVC digital television service, the service information includes information about an event related to the service, the event information or the service description information includes video feature information of the UHD video service data, and the video feature information includes video codec information and frame rate information of the UHD video service data, multiplexing the signaling information and the UHD video data into a transport stream (S130), channel-coding the transport stream (S140), and modulating the transport stream and transmitting the modulated stream (S150).

The event information may include information indicating the type of a target service and information indicating whether the service linked to the event is a simulcast service or a time-off service.

The type of the target service may indicate that the target service is a UHD service based on the UHD video service data.

The event information may include link information of the target service, and the link information may indicate that the target service is a UHD service and/or a 3DTV service.

Another embodiment of the present invention provides a signal receiving method including receiving a broadcast signal containing a transport stream (S210), demodulating the broadcast signal, demultiplexing the transport stream from the demodulated broadcast signal into signaling information and video service data, wherein the signaling information includes service description information describing a service, the service description information includes service type information determining the type of the service, the service type information indicates that the service is an HEVC digital television service, the service information includes information about an event related to the service, the event information or the service description information includes video feature information of the UHD video service data, and the video feature information includes video codec information and frame rate information of the UHD video service data, decoding the signaling information, and decoding the video service data based on the decoded signaling information.

Another embodiment of the present invention provides a signal transmitting apparatus including an encoder (610) for encoding video service data, wherein the video service data includes UHD video service data, a signaling information encoding unit (620) for creating signaling information, wherein the signaling information includes service description information describing a service, the service description information includes service type information determining the type of the service, the service type information indicates that the service is an HEVC digital television service, the service information includes information about an event related to the service, the event information or the service description information includes video feature information of the UHD video service data, and the video feature information includes video codec information and frame rate information of the UHD video service data, a multiplexing unit (630) for multiplexing the signaling information and the UHD video data into a transport stream, a channel coding unit (640) for channel-coding the transport stream, and a transmitting unit (650) for modulating the transport stream and transmitting the modulated stream.

A further embodiment of the present invention provides a signal receiving apparatus including a receiving unit (701) for receiving a broadcast signal containing a transport stream, a demodulating unit (705) for demodulating the broadcast signal, a demultiplexing unit (710) for demultiplexing the transport stream from the demodulated broadcast signal into signaling information and video service data, wherein the signaling information includes service description information describing a service, the service description information includes service type information determining type of the service, the service type information indicates that the service is an HEVC digital television service, the service information includes information about an event related to the service, the event information or the service description information includes video feature information of the UHD video service data, and the video feature information includes video codec information and frame rate information of the UHD video service data, a signaling information decoding unit (720) for decoding the signaling information, and a video decoder (730) for decoding the video service data based on the decoded signaling information.

### Advantageous Effects

According to an embodiment of the present invention, a signal transceiving apparatus and a signal transceiving method are compatible with existing HD broadcasts while providing an ultra-high-definition video broadcast service.

According to another embodiment of the present invention, a signal transceiving apparatus and a signal transceiving method are capable of providing an ancillary service necessary for an ultra-high-definition video broadcast service.

According to another embodiment of the present invention, a signal transceiving apparatus and a signal transceiving method are capable of displaying a subtitle suitable for an ultra-high-definition video broadcast service.

According to a further embodiment of the present invention, a signal transceiving apparatus and a signal transceiving method are capable of signaling that a target service is a UHD service and/or a 3DTV service and transceiving link information of the UHD service and the 3DTV service such that a receiver performs switching between the UHD service and the 3DTV service, which are identified.

### DESCRIPTION OF DRAWINGS

FIG. 1 is a view illustrating an example of a signal transmitting method according to an embodiment of the present invention.

FIG. 2 is a view illustrating an embodiment of a signal transceiving apparatus according to the present invention.

FIG. 3 is a view illustrating signaling information according to an embodiment of the present invention.

FIG. 4 is a view illustrating signaling information according to another embodiment of the present invention.

FIG. 5 is a view illustrating the features of a video based on stream_content and component_type field values.

FIG. 6 is a view illustrating signaling information according to a further embodiment of the present invention.

FIG. 7 is a view illustrating information (advanced_event_linkage_info( )) included in linkage_descriptor as an example of a method of signaling a UHD broadcast service or event using link information.

FIG. 8 is a view illustrating an example of signaling a subtitle stream for a UHD service according to another embodiment of the present invention.

FIG. 9 is a view illustrating subtitle_descriptor( ) according to another embodiment of the present invention.

FIG. 10 is a view illustrating a scheme of signaling a target service that is included in signaling information and is linked.

FIG. 11 is a view illustrating another example providing link information of a target service according to an embodiment of the present invention.

FIG. 12 is a view illustrating a link type of the target service according to the embodiment of the present invention.

FIG. 13 is a view illustrating detailed information of a target service of target information according to an embodiment of the present invention.

FIG. 14 is a view illustrating detailed information of a target service of link information according to an embodiment of the present invention.

FIG. 15 is a view illustrating bit depth information included in the detailed information of the target service of the link information according to the embodiment of the present invention.

FIG. 16 is a view illustrating color space information included in the detailed information of the target service of the link information according to the embodiment of the present invention.

FIG. 17 is a view illustrating dynamic range information included in the detailed information of the target service of the link information according to the embodiment of the present invention.

FIG. 18 is a view illustrating frame rate information included in the detailed information of the target service of the link information according to the embodiment of the present invention.

FIG. 19 is a view illustrating codec information included in the detailed information of the target service of the link information according to the embodiment of the present invention.

FIG. 20 is a view illustrating 3D format information included in the detailed information of the target service of the link information according to the embodiment of the present invention.

FIG. 21 is a view illustrating another example of the link information of the target service according to the embodiment of the present invention.

FIG. 22 is a view illustrating a further example of the link information of the target service according to the embodiment of the present invention.

FIG. 23 is a view illustrating target service type information of the link information of the target service according to the embodiment of the present invention.

FIG. 24 is a view illustrating codec type information of the link information of the target service according to the embodiment of the present invention.

FIG. 25 is a view illustrating tier information of a target service codec of the link information of the target service according to the embodiment of the present invention.

FIG. 26 is a view illustrating dynamic range information of the link information of the target service according to the embodiment of the present invention.

FIG. 27 is a view illustrating color gamut information of the target service of the link information of the target service according to the embodiment of the present invention.

FIG. 28 is a view illustrating a signal receiving apparatus according to an embodiment of the present invention.

FIG. 29 is a view illustrating a signal receiving method according to an embodiment of the present invention.

FIG. 30 is a view illustrating a signal transmitting apparatus according to an embodiment of the present invention.

FIG. 31 is a view illustrating a signal receiving apparatus according to another embodiment of the present invention.

### BEST MODE

Now, embodiments of the present invention will be described with reference to the accompanying drawings.

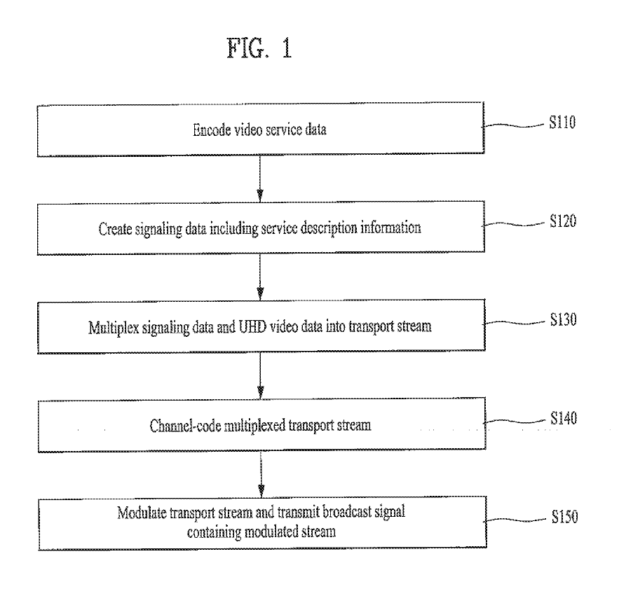

FIG. 1 is a view illustrating an example of a signal transmitting method according to an embodiment of the present invention.

Video service data are encoded (S110). For example, the video service data may include UHD video service data, and the UHD video service data may have a resolution of 4K, 8K, 16K, etc.

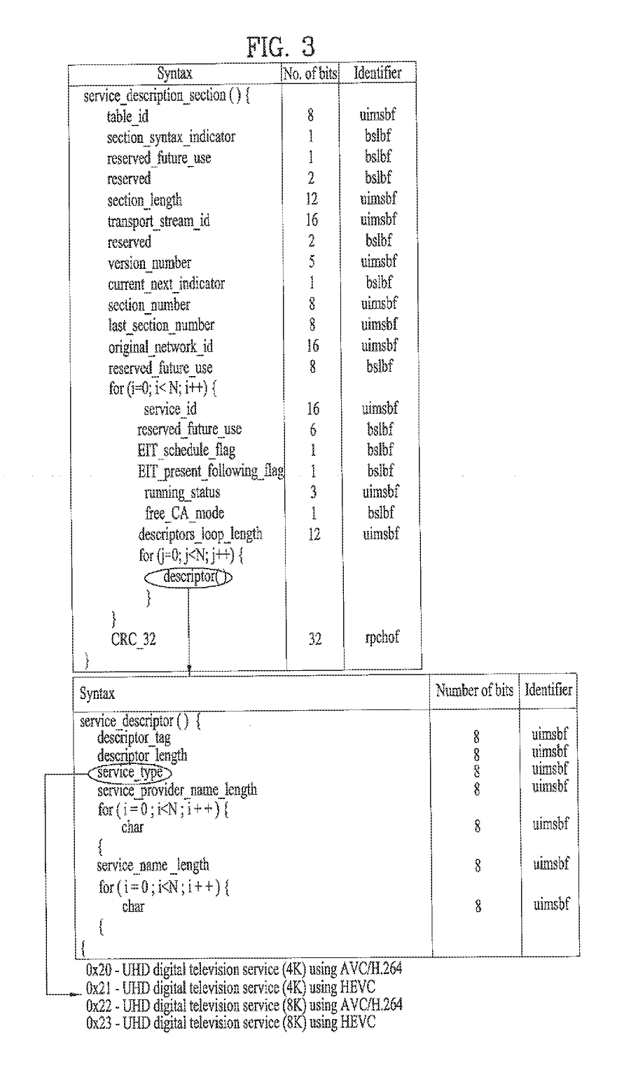

Signaling data including service description information describing services are created (S120). The service description information may include service type information determining the type of a service. The service description information will be described in detail with reference to FIG. 3. When the service type information has a specific value, the service type information may indicate that the service is an HEVC digital television service provided by the UHD video service data.

The signaling data may include information indicating the features of the UHD video data.

Signaling information may include event information providing information about an event related to the services. The signaling data may include link information about a target surface that may be linked with the current service. Detailed examples thereof will be described with reference to FIGS. 7, 11, 21, and 22.

For example, the signaling information may include service description information describing a service, and the service description information may include a first descriptor having service type information determining a service type. When the service type has a first coding value, the first coding value may indicate that the service is an HEVC digital television service.

The service information may include information about an event related to the service. The event information or the service description information may include a second descriptor, and the second descriptor information may include information about the video features of the UHD video service data.

The video feature information may include video codec information and frame rate information of the UHD video service data.

The event information may include a third descriptor, the third descriptor may include information indicating the type of the target service, and the third descriptor may indicate whether the service linked to the event is a simulcast service or a time-off service.

The type of the target service may indicate that the target service is a UHD service based on the UHD video service data. The type of the target service may indicate that the target service is a UHD service based on the UHD video service data. The event information may include a third descriptor, and the third descriptor may include information indicating a link type. The information indicating the link type may indicate that the linked service is a UHD service and/or 3DTV service.

The signaling data and the UHD video data are multiplexed into a transport stream (S130).

The multiplexed transport stream performs channel coding (S140).

The transport stream is modulated, and a broadcast signal containing the modulated stream is transmitted (S150).

The signaling information may include event information providing information about an event related to services. The event information may include a descriptor, and this descriptor may include information indicating the type of the target service.

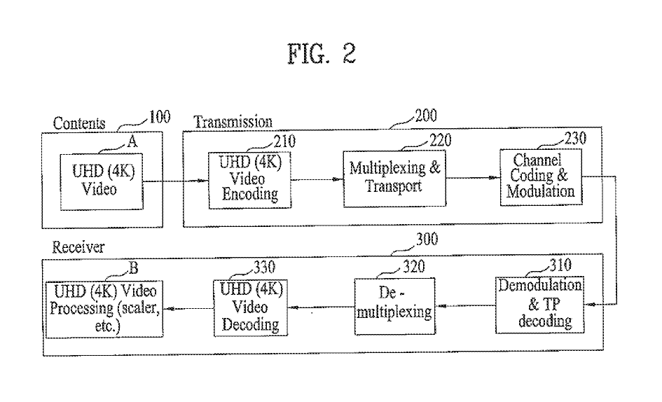

FIG. 2 is a view illustrating an embodiment of a signal transceiving apparatus according to the present invention.

A content provider 100 may create a UHD video as content. For example, the content provider 100 may create a UHD video providing a UHD broadcast service using a camera that is capable of capturing a 4K UHD video.

A transmitter 200 includes a video encoder 210, a multiplexing unit 220, and a channel coding and modulating unit 230.

The video encoder 210 compresses and encodes an ultra-high-definition (UHD) video. For example, the video encoder 210 may use a coding standard, such as High Efficiency Video Coding (HEVC), to encode a 4K UHD video.

The multiplexing unit 220 multiplexes a stream of the encoded UHD video, another stream, such as an audio stream, and signaling information, which will hereinafter be described, to output a transport stream.

The channel coding and modulating unit 230 channel-codes and multiplexes the transport stream to transmit the transport stream as a broadcast signal.

A receiver 300 includes a demodulating unit 310, a de-multiplexing unit 320, and a video decoder 330.

The demodulating unit 310 receives and demodulates the transmitted broadcast signal to output the transport stream.

The de-multiplexing unit 320 may de-multiplex the transport stream to output the video stream, the audio stream, and the signaling information, which will hereinafter be described.

The video decoder 330 may decode an ultra-high-definition (UHD) video. For example, the video decoder 330 may decode a 4K UHD video B and then process the 4K UHD video. For example, the receiver may perform video processing for display, such as image quality processing and frame rate conversion of the decoded video.

An embodiment for transmitting information signaling a UHD broadcast service when the UHD broadcast service is transmitted by the transceiving system illustrated above will be described.

According to an embodiment of the present invention, it is possible to transmit a UHD video broadcast, e.g. a broadcast service having a resolution of 4K. A channel transmitting a UHD video service may include information indicating, for example, 4K UHD video service. In addition, according to an embodiment of the present invention, information indicating that a current event or a future event includes a UHD video service, such as a 4K UHD video service, may also be transmitted. In this case, detailed information about a UHD video component, such as a 4K UHD video component, may also be transmitted together with a video coding profile.

According to an embodiment of the present invention, it is possible to transmit a conventional service, such as an HD video service, a UHD video service, such as a 4K UHD video service, interlocked with an event, or information about the event. In this case, it is also possible to transmit not only the channel number of a channel interlocked therewith but also information about physical properties (physical medium type, modulation type, etc.) of the channel.

Hereinafter, embodiments of the present invention will be described in more detail.

FIG. 3 is a view illustrating signaling information according to an embodiment of the present invention. In this figure, a service description table (SDT) of service information (SI) is illustrated as signaling information.

Information contained in the SDT is as follows.

A table_id field indicates an identifier of the table.

A section_syntax_indicator field indicates a 1-bit field which is set to 1 for a SDT table section (section_syntax_indicator: The section_syntax_indicator is a 1-bit field which shall be set to “1”).

A section_length field indicates the length of a section expressed by the number of bytes (section_length: This is a 12-bit field, the first two bits of which shall be “00”. It specifies the number of bytes of the section, starting immediately following the section_length field and including the CRC. The section_length shall not exceed 1 021 so that the entire section has a maximum length of 1 024 bytes.)

A transport_stream_id field indicates a TS identifier provided by the SDT while being distinguished from any other multiplex within the delivery system (transport_stream_id: This is a 16-bit field which serves as a label for identification of the TS, about which the SDT informs, from any other multiplex within the delivery system.)

A version_number field indicates a version number of this sub table (version_number: This 5-bit field is the version number of the sub_table. The version_number shall be incremented by 1 when a change in the information carried within the sub_table occurs. When it reaches value “31”, it wraps around to “0”. When the current_next_indicator is set to “1”, then the version_number shall be that of the currently applicable sub_table. When the current_next_indicator is set to “0”, then the version_number shall be that of the next applicable sub_table.)

A current_next_indicator field indicates whether this sub table is currently applicable or next applicable (current_next_indicator: This 1-bit indicator, when set to “1” indicates that the sub_table is the currently applicable sub_table. When the bit is set to “0”, it indicates that the sub_table sent is not yet applicable and shall be the next sub_table to be valid.)

A section_number field indicates a section number (section_number: This 8-bit field gives the number of the section. The section_number of the first section in the sub_table shall be “0x00”. The section_number shall be incremented by 1 with each additional section with the same table_id, transport_stream_id, and original_network_id.)

A last_section_number field indicate the last section number (last_section_number: This 8-bit field specifies the number of the last section (that is, the section with the highest section_number) of the sub_table of which this section is part.)

An original_network_id field indicates an identifier of network ID of the delivery system (original_network_id: This 16-bit field gives the label identifying the network_id of the originating delivery system.)

A service_id field indicates a server identifier within the TS (service_id: This is a 16-bit field which serves as a label to identify this service from any other service within the TS. The service_id is the same as the program_number in the corresponding program_map_section.)

An EIT_schedule_flag field indicates whether EIT schedule information for the service is present in the current TS (EIT_schedule_flag: This is a 1-bit field which when set to “1” indicates that EIT schedule information for the service is present in the current TS, see TR 101 211 [i.2] for information on maximum time interval between occurrences of an EIT schedule sub_table). If the flag is set to 0 then the EIT schedule information for the service should not be present in the TS.)

An EIT_present_following_flag field indicates whether EIT_present_following information for the service is present in the current TS (EIT_present_following_flag: This is a 1-bit field which when set to “1” indicates that EIT_present_following information for the service is present in the current TS, see TR 101 211 [i.2] for information on maximum time interval between occurrences of an EIT present/following sub_table. If the flag is set to 0 then the EIT present/following information for the service should not be present in the TS.)

A running_status field indicates the status of a service as defined in Table 6 of a DVB-SI document (running_status: This is a 3-bit field indicating the status of the service as defined in table 6. For an NVOD reference service the value of the running_status shall be set to “0”.)

A free_CA_mode field indicates whether all the component streams of the service are scrambled (free_CA_mode: This 1-bit field, when set to “0” indicates that all the component streams of the service are not scrambled. When set to “1” it indicates that access to one or more streams may be controlled by a CA system.)

A descriptors_loop_length field indicates the length of the following descriptors (descriptors_{—} loop_ This 12-bit field gives the total length in bytes of the following descriptors).

CRC_32 is a 32-bit field that contains the CRC value (CRC_32: This is a 32-bit field that contains the CRC value that gives a zero output of the registers in the decoder.)

Various descriptors may be located at the position of a descriptor following the descriptors_loop_field. It is possible to signal whether a UHD service is transmitted to the channel using the descriptors.

For example, service_descriptor may be located at the position of a descriptor following the descriptors_loop_length field, which will be described in detail. Hereinafter, service_descriptor will be described.

Descriptor_tag may include an identifier that identifies this descriptor, and descriptor_length indicates the length of the descriptor.

Service_type may signal whether a UHD video service is transmitted to a corresponding service or channel.

Service_provider_name_length indicates the length of a service provider displayed as the following char.

Service_name_length indicates the length of a service name displayed as the following char field.

For example, service_type of a UHD broadcast service may be assigned using the following values.

In the case in which service_type is 0x20, it indicates a UHD digital television service (4K) using AVC/H.264.

In the case in which service_type is 0x21, it indicates a UHD digital television service (4K) using HEVC.

In the case in which service_type is 0x22, it indicates UHD digital television service (8K) using AVC/H.264.

In the case in which service_type is 0x23, it indicates a UHD digital television service (8K) using HEVC.

Consequently, it is possible to obtain information indicating which UHD service is transmitted to the channel based on the signaling information according to the embodiment of the present invention. According to this embodiment, it is possible to signal a UHD service at a service level.

FIG. 4 is a view illustrating signaling information according to another embodiment of the present invention. In this figure, an event information table (EIT) of service information (SI) is illustrated as signaling information.

A table_id field indicates an identifier of the table.

A section_syntax_indicator field indicates a 1-bit field which is set to 1 for an EIT table section (section_syntax_indicator: The section_syntax_indicator is a 1-bit field which shall be set to “1”.)

A section_length field indicates the length of a section expressed as a number of bytes (section_length: This is a 12-bit field. It specifies the number of bytes of the section, starting immediately following the section_length field and including the CRC. The section_length shall not exceed 4 093 so that the entire section has a maximum length of 4 096 bytes.)

A service_id field indicates a server identifier within the TS (service_id: This is a 16-bit field which serves as a label to identify this service from any other service within a TS. The service_id is the same as the program_number in the corresponding program_map_section.)

A version_number field indicates a version number of this sub table (version_number: This 5-bit field is the version number of the sub_table. The version_number shall be incremented by 1 when a change in the information carried within the sub_table occurs. When it reaches value 31, it wraps around to 0. When the current_next_indicator is set to “1”, then the version_number shall be that of the currently applicable sub_table. When the current_next_indicator is set to “0”, then the version_number shall be that of the next applicable sub_table.)

A current_next_indicator field indicates whether this sub table is currently applicable or next applicable (current_next_indicator: This 1-bit indicator, when set to “1” indicates that the sub_table is the currently applicable sub_table. When the bit is set to “0”, it indicates that the sub_table sent is not yet applicable and shall be the next sub_table to be valid.)

A section_number field indicates a section number (section_number: This 8-bit field gives the number of the section. The section_number of the first section in the sub_table shall be “0x00”. The section_number shall be incremented by 1 with each additional section with the same table_id, service_id, transport_stream_id, and original_network_id. In this case, the sub_table may be structured as a number of segments. Within each segment the section_number shall increment by 1 with each additional section, but a gap in numbering is permitted between the last section of a segment and the first section of the adjacent segment.)

A last_section_number indicate the last section number (last_section_number: This 8-bit field specifies the number of the last section (that is, the section with the highest section_number) of the sub_table of which this section is part.)

A transport_stream_id field indicates a TS identifier provided by the SDT while being distinguished from any other multiplex within the delivery system (transport_stream_id: This is a 16-bit field which serves as a label for identification of the TS, about which the EIT informs, from any other multiplex within the delivery system.)

An original_network_id field indicates an identifier of network ID of the delivery system (original_network_id: This 16-bit field gives the label identifying the network_id of the originating delivery system.)

A segment_last_section_number field indicates the number of the last section of this segment of the sub table (segment_last_section_number: This 8-bit field specifies the number of the last section of this segment of the sub_table. For sub tables which are not segmented, this field shall be set to the same value as the last_section_number field.)

A last_table_id field indicates an identifier of the last table (last_table_id: This 8-bit field identifies the last table_id used (see table 2).)

An event_id field indicates an identification number of the event (event_id: This 16-bit field contains the identification number of the described event (uniquely allocated within a service definition.)

A start_time field indicates a start time of the event (start_time: This 40-bit field contains the start time of the event in Universal Time, Co-ordinated (UTC) and Modified Julian Date (MJD) (see annex C). This field is coded as 16 bits giving the 16 LSBs of MJD followed by 24 bits coded as 6 digits in 4-bit Binary Coded Decimal (BCD). If the start time is undefined (e.g. for an event in a NVOD reference service) all bits of the field are set to “1”.)

A running_status field indicates the status of an event as defined in Table 6 of a DVB-SI document (running_status: This is a 3-bit field indicating the status of the event as defined in table 6. For an NVOD reference event the value of the running_status shall be set to “0”.)

A free_CA_mode field indicates whether any of the component streams of the service are scrambled (free_CA_mode: This 1-bit field, when set to “0” indicates that all the component streams of the event are not scrambled. When set to “1” it indicates that access to one or more streams is controlled by a CA system.)

A descriptors_loop_length field indicates the length of the following descriptors (descriptors_loop_length: This 12-bit field gives the total length in bytes of the following descriptors.)

CRC_32 is a 32-bit field that contains the CRC value (CRC_32: This is a 32-bit field that contains the CRC value that gives a zero output of the registers in the decoder)

Component_descriptor may be included at the position of a descriptor following the descriptors_loop_length field.

The component descriptor is located in the EIT (or a descriptor loop of the SDT) to inform of features of a video (and audio) stream contained in a corresponding event. The receiver may determine whether it is possible to decode the corresponding event using this information.

The receiver may signal information about the features of the UHD video stream using a stream_content field and a component_type field in component_descriptor. That is, the receiver may signal may check the features of the video including the codec types of the video stream contained in the corresponding event (or service) using the stream_content field and the component_type field.

Component_descriptor includes descriptor_tag including an identifier that identifies this descriptor and descriptor_length indicating the length of the descriptor.

The stream_content field indicates the type of a stream and the component_type field indicates a video or audio data type. A combination of the stream or component types based on these two fields will hereinafter be described in detail.

Component_tag has the same value as a component_tag field of a stream identifier descriptor.

An ISO_639_language_code field identifies a language of the component. A Text_char field indicates the text description of the component stream.

The receiver may signal information about features of a UHD video stream using the stream_content field and the component_type field. Consequently, the receiver may know the features of the video including the codec types of the UHD video stream contained in the corresponding event (or service) using the stream_content field and the component_type field of the received SDT and display a service using the same. According to the embodiment of the present invention, it is possible to signal a UHD service at the event level.

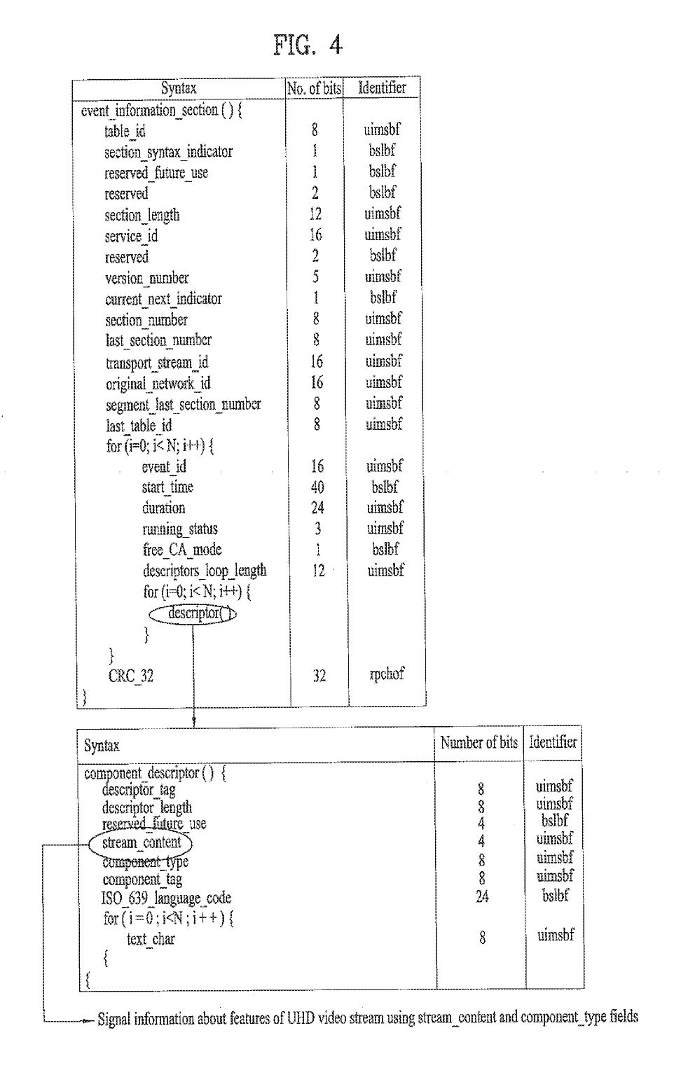

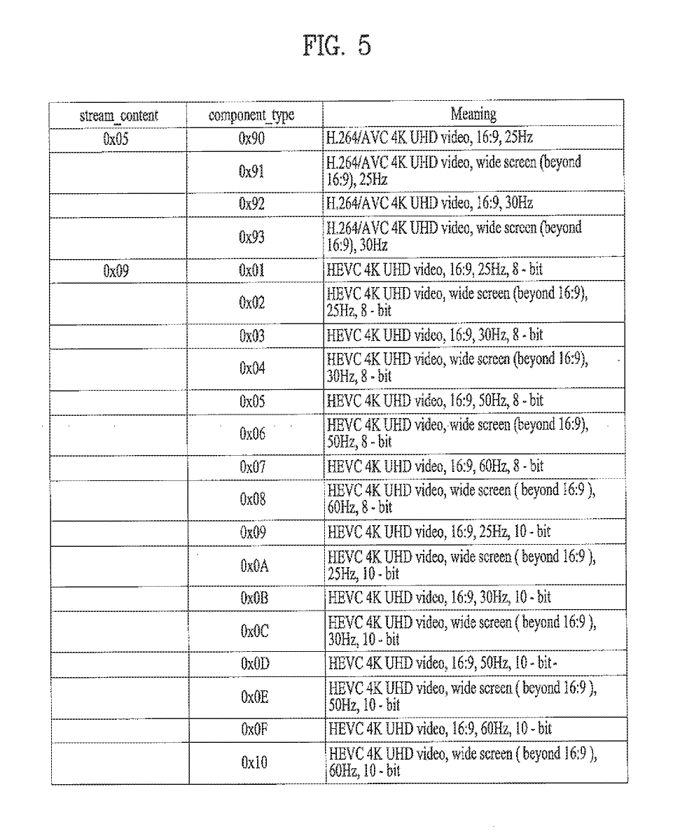

FIG. 5 is a view illustrating the features of the video based on the stream_content and component_type field values described above. For example, in this embodiment, the features of the video are illustrated based on a stream transporting a video having a 4:2:0 sampling chroma format.

For example, in the case in which a stream_content field for a specific stream is 0x05 and a component_type field value for the specific stream is 0x90, a component transported through the stream indicates video data having an H.264/AVC codec, a 4K UHD video resolution, an aspect ratio of 16:9, and a frame rate of 25 Hz.

In the case in which the stream_content field is 0x05 and the component_type field value is 0x91, a component transported through the stream indicates video data having an H.264/AVC codec, a 4K UHD video resolution, an aspect ratio of 16:9 or more (a wide screen aspect ratio), and a frame rate of 25 Hz.

In the case in which the stream_content field is 0x05 and the component_type field value is 0x92, a component transported through the stream indicates video data having an H.264/AVC codec, a 4K UHD video resolution, an aspect ratio of 16:9, and a frame rate of 30 Hz.

In the case in which the stream_content field is 0x05 and the component_type field value is 0x93, a component transported through the stream indicates video data having an H.264/AVC codec, a 4K UHD video resolution, an aspect ratio of 16:9 or more (a wide screen aspect ratio), and a frame rate of 30 Hz.

Similarly, in the case in which a stream_content field for a specific stream is 0x09 and a component_type field value for the specific stream is 0x01, a component transported through the stream indicates video data having an HEVC codec, a 4K UHD video resolution, an aspect ratio of 16:9, a frame rate of 25 Hz, and a bit-depth format of 8 bits.

In addition, similarly, in the case in which a stream_content field for a specific stream is 0x09 and a component_type field value for the specific stream is 0x02, a component transported through the stream indicates video data having an HEVC codec, a 4K UHD video resolution, an aspect ratio of 16:9 or more (a wide screen aspect ratio), a frame rate of 25 Hz, and a bit-depth format of 8 bits.

The features of the video transmitted by other video components may be signaled as illustrated in this drawing.

This embodiment has been illustrated based on a video stream having a 4:2:0 chroma format. A 12-bit mode may also be added through extension of the illustrated list. In this case, for example, component_type may have a value of 0x11 to 0x18 based on a combination of the codec, the resolution, the aspect ratio, and the frame rate.

For a video stream having a 4:2:0 chroma format, for example, a value of 0x19 to 0x30 based on a combination of the codec, the resolution, the aspect ratio, and the frame rate may be assigned as the component_type.

In the same manner, for an 8K UHD video stream, for example, a value of 0x31 to 0x60 based on a combination of the codec, the resolution, the aspect ratio, and the frame rate may be assigned as component_type.

The value assigned in this example is an illustrative value, and other values may be assigned. According to an embodiment of the present invention, it is possible to transmit codec information of a UHD video based on a combination of the values of the stream_content and component_type fields. The codec information of the UHD video may include HEVC 4K information.

In addition, aspect ratio information may be described based on a combination of the values of the stream_content and component_type fields of an EIT or SDT. The aspect ratio information may include information about 16:9 and wide screen formats.

According to an embodiment of the present invention, frame rate information or bit depth information may be described based on a combination of the values of the stream_content and component_type fields. The frame rate information may describe information about 25 Hz, 30 Hz, 50 Hz, and 60 Hz rates, and the bit depth information may describe information about depths of 8 bits and 10 bits.

Next, an example of signaling information about a UHD broadcast corresponding to the current broadcast at the event level will be described.

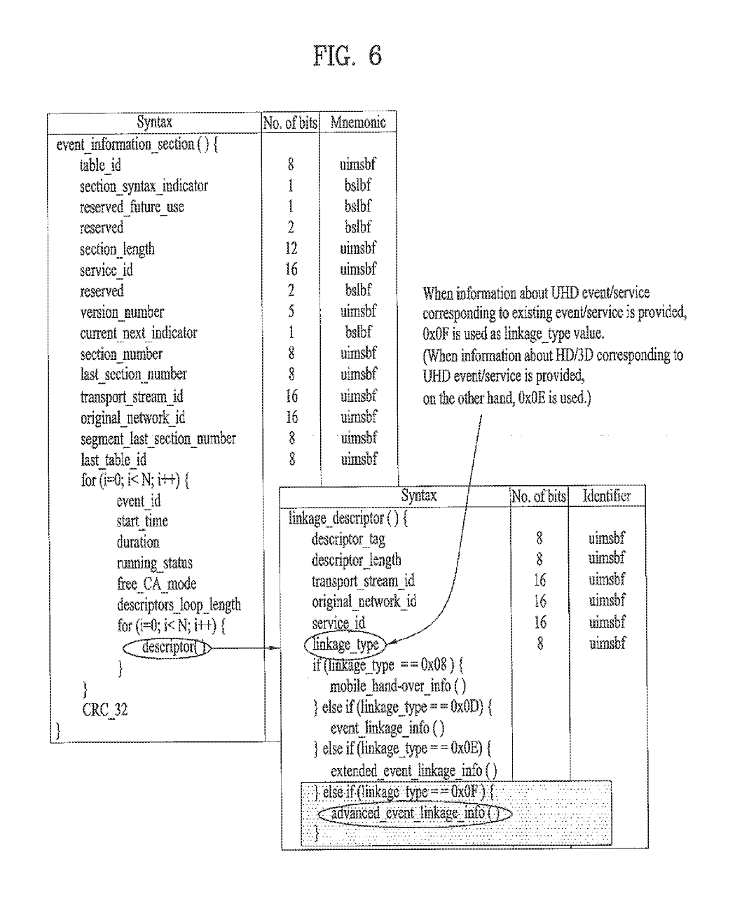

FIG. 6 is a view illustrating signaling information according to a further embodiment of the present invention. This figure illustrates linkage_descriptor ( ) as an example of link information included in an event information table (EIT) of service information (SI).

A transport_stream_id field indicates an identifier that identifies a TS including an information service, and an original_network_id field indicates a network identifier of the original delivery system.

A service_id field identifies an information service in the TS.

A linkage_type field indicates the type of a linkage connecting the information service.

Another embodiment that provides information about a UHD broadcast corresponding to a broadcast service that a user is currently viewing is as follows.

As a first example providing link information capable of signaling a target service, for example, when information about a UHD event/service corresponding to an existing event or service is provided, a newly assigned value 0x0F may be used as the value of linkage_type. Similarly, when information about an HD service or a 3D service corresponding to a UHD event/service is provided, 0x0E may be used.

In the case in which a linkage_type field is 0x0F, information capable of signaling a UHD event/service (advanced_event_linkage_info ( )) may be included. The information capable of signaling the UHD event/service will be described in detail with reference to the following drawings.

As another example providing link information that is capable of signaling a target service, in the case in which a linkage_type field is 0x0F, another type of information (extended_event_linkage_info ( )) may be used in order to signal the UHD event/service, instead of the above-described information (advanced_event_linkage_info ( )). That is, a new linkage_type value (e.g. 0x0F) may be assigned in order to signal that a target or linked event/service is a UHD service, and it may be indicated that the target or linked event/service is a UHD service using a combination of the link_type value and the linkage_type value. In this case, existing information may be utilized, thereby further improving compatability.

In the case in which it is indicated that the target or linked event/service is the UHD service using information (extended_event_linkage_info ( )) included depending on the value of the linkage_type field, it may be indicated that the target or linked event/service is the UHD service using the link_type field added to the information. Since the link_type field of extended_event_linkage_info ( ), which is information that may be included in an EIT, is 2-bit, however, detailed profile information about the UHD service may be briefly signaled. For example, in the case in which link_type is 0, a 4K UHD, 8-bit, and 4:2:0 sampling video may be signaled. In the case in which link_type is 1, a 4K UHD, 10-bit, and 4:2:2 sampling video may be signaled. In the case in which link_type is 2, a 4K UHD, 12-bit, and 4:2:2 sampling video may be signaled. Detailed examples thereof will be described hereinafter.

As another example providing link information capable of signaling a target service, detailed information related to the UHD may be added instead of using the link_type field, which will be described in detail with reference to FIGS. 11, 21, and 22. Embodiments that are capable of providing link information in the case in which the target service is a UHD service will be described in detail.

FIG. 7 is a view illustrating information (advanced_event_linkage_info( )) included in linkage_descriptor illustrated above as an example of a method of signaling a UHD broadcast service or event using link information.

For example, in the case in which a linkage_type field is 0x0F, information (advanced_event_linkage_info ( )) signaling a UHD broadcast service or an event, which is a target service, may be included in linkage_descriptor, which is link information.

A num_link_event field may indicate the number of links.

A link_simulcast field indicates whether a corresponding event or service is broadcast simultaneously with the current event/service. For example, in the case in which this value is ‘1’, it indicates that a corresponding event or service is broadcast simultaneously with the current event/service without a time difference. Consequently, it may indicate whether the service linked to the event is a simulcast service or a time-off service.

A link_delivery_type field may indicate the type of a path through which the corresponding event or service is broadcast (terrestrial, satellite, cable, IP, etc.). In the case in which the corresponding event or service is based on the same path or the same type, a value of ‘001’ may be designated.

In the case in which the corresponding event or service is based on the same path but a different parameter (for example, a parameter related to a modulation type), on the other hand, information corresponding to the path may be designated (for example, a value between ‘010’ and ‘100’). Detailed parameter information may be signaled through delivery_detail_info ( ). The link_delivery_type field may signal the same transmission path, cable, IP, or terrestrial of the same event.

Link type indicates the service type of the corresponding event or service. For example, link_type may indicate the following information of a UHD video based on respective values.

‘001’—4K UHD, 8-bit, and 4:2:0

‘010’—4K UHD, 10-bit, and 4:2:0

‘011’—4K UHD, 10-bit, and 4:2:2

In addition, link_event_id, link_original_network_id, link_transport_stream_id, and link_service_id fields respectively indicate an event identifier (event_id), original_network_id, transport_stream_id, and service_id of the corresponding event or service.

Delivery_detail_info ( ) indicates a physical transmission parameter for a linked event or service. For example, it is possible to signal information, such as a modulation type, frequency information, and an FEC type, of event data which are transmitted using the same.

In the case in which there is a time difference between the linked event or service and the current event or service, time_shift_detail_info ( ) signals information about the time information. A field providing information about the time delay after which it will be broadcast, in minutes, may be included in some embodiments of the present invention. As another example signaling this value, event_id and time information about an event identified by the event_id may be referred to from a relevant EIT.

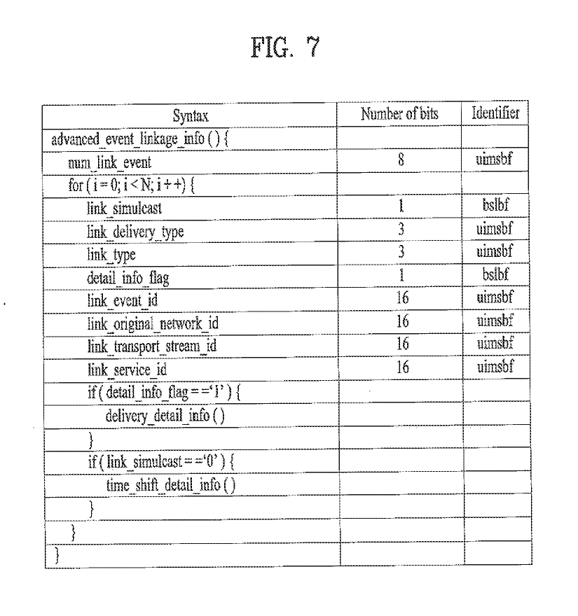

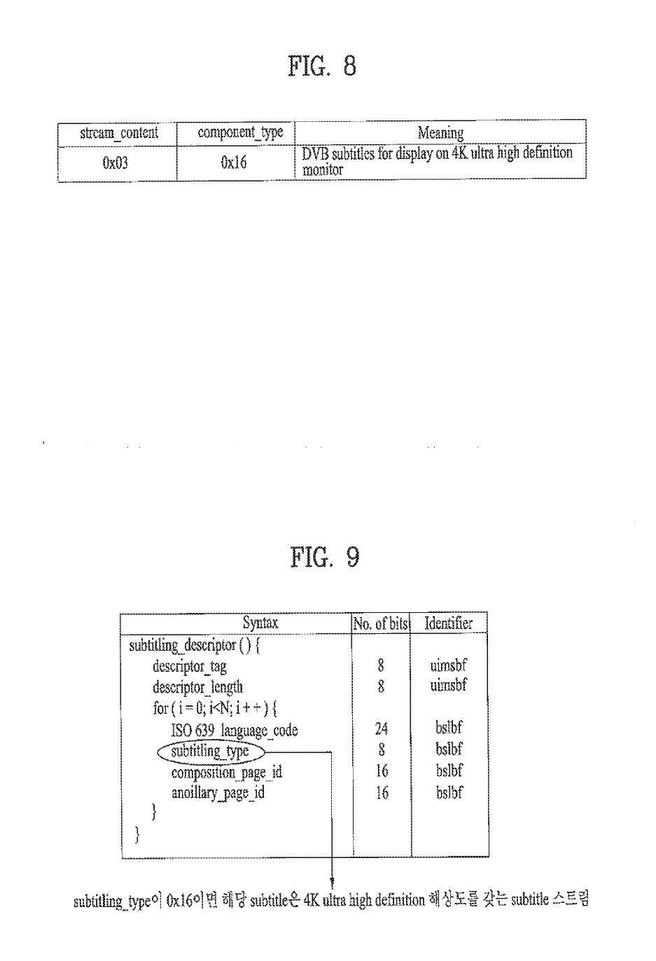

FIG. 8 is a view illustrating an example of signaling a subtitle stream for a UHD service according to another embodiment of the present invention.

It is possible to identify a component transmitting a subtitle displayed on a monitor that is capable of displaying a UHD video using a value of stream_content and a value of component_type. In the case in which stream_content is 0x03 and component_type is 0x16, the corresponding subtitle may be a subtitle stream having a 4K UHD resolution.

In addition, in the case in which a type value of an elementary stream (ES) is 0x06, the stream transmits the subtitle. In this case, subtitle_descriptor( ) may be included at the position of a descriptor of a PMT, as illustrated in FIG. 9.

FIG. 9 is a view illustrating subtitle_descriptor( ) as an example of signaling information describing a subtitle stream according to another embodiment of the present invention.

Subtitle_descriptor( ) is signaling information describing a subtitle stream for a UHD service, and may be located in a PMT. A descriptor tag or descriptor_length indicate the identifier and length of this descriptor, respectively.

An ISO_639_language_code field indicates the character language code of a language of the subtitle.

A subtitling_type field indicates information about display and subtitle content. For example, in the case in which subtitling_type is 0x16, the corresponding subtitle may be a subtitle stream having a 4K UHD resolution.

A composition_page_id field indicates information that identifies a composition page.

An ancillary_page_id field indicates information that identifies an ancillary (selective) page.

In addition, in the case in which, for a UHD service having a size of 3840×2160, the size of a subtitle has a HD resolution (1920×1080), parameters that define a window for the subtitle may be defined as follows in the subtitle stream.

The position of the leftmost pixel of the subtitle that is relatively positioned at the leftmost pixel of the display (display_window_horizontal_position_minimum) may be defined as 960.

The position of the rightmost pixel of the subtitle that is relatively positioned at the rightmost pixel of the display (display_window_horizontal_position_minimum) may be defined as 2879.

The position of the uppermost pixel of the subtitle that is relatively positioned at the uppermost pixel of the display (display_window_vertical_position_minimum) may be defined as 540.

The position of the lowermost pixel of the subtitle that is relatively positioned at the lowermost pixel of the display (display_window_vertical_position_maximum) may be defined as 1619. These values may be changed depending upon the size of the resolution of the UHD service.

Hereinafter, embodiments capable of providing link information about the target service described above in detail will be described in detail with reference to the drawings.

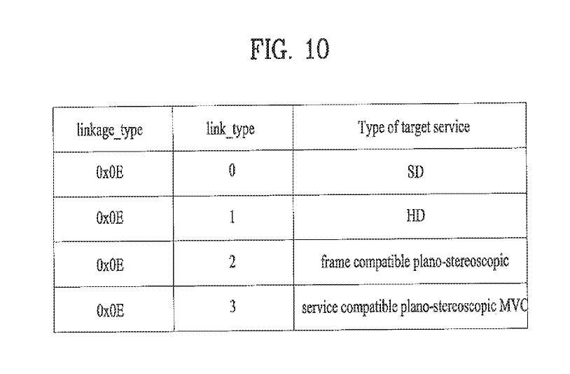

FIG. 10 is a view illustrating a scheme of signaling a target service that is included in signaling information and is linked.

As described above, a service/event linked to the current service may be identified using linkage_type included in linkage_descriptor, which is a descriptor included in an EIT, and link_type included in detailed link information (e.g. advanced_event_linkage_info ( ) described above) in linkage_descriptor. In this example, in the case in which linkage_type is 0x0E and link_type is 0 to 3, it indicates that the target service is an SD service, an HD service, a frame compatible piano-stereoscopic service, and a service compatible piano-stereoscopic MVC service.

When the above signaling scheme is used, however, the number of bits assigned to link_type is limited in the case in which the target service is a UHD service. Consequently, additional information may be needed to described the target service in more detail.

For example, the EIT may include additional linkage_descriptor having a new value of linkage_type, and a target or linked UHD service and/or 3DTV service may be identified using the value of the link_type field and the new value of linkage_type.

Alternatively, additional fields capable of identifying the UHD service and/or 3DTV service may be included, instead of the link_type field, such that service information (frame compatible, 3D—service compatible, and UHD), codec information (MPEG-2, H.264/AVC, H.265/HEVC, . . . ), and video-related information (video profile, level, tier, dynamic range, color gamut, video resolution, frame rate, bit-depth, and display aspect ratio) of the target (or linked) UHD service and/or 3DTV service are signaled. Detailed embodiments will be described hereinafter. According to the following embodiments, it is possible to signal that the target service is a UHD service and/or 3DTV service and to transceive link information of the UHD service and the 3DTV service such that a receiver performs switching between the UHD service and the 3DTV service, which are identified.

FIG. 11 is a view illustrating another example providing link information of a target service according to an embodiment of the present invention.

Information illustrated in this figure is target service information based on the value of linkage_type (e.g. linkage_type=0x0F), and additional_extended_event_linkage_info ( ) is link signaling information of a target service that may be included in an EIT or in linkage_descriptor, which is link information of the EIT.

A target_event_id field indicates an identifier of a target event, and a target_listed field indicates whether a service defined by original_network_id, transport_stream_id, and service_id is included in an SDT.

An event_simulcast field indicates whether a target event and a source event are simulcast.

A target_id_type field may be used to identify a target service or services together with an original_network_id_flag field and a service_id_flag field.

An original_network_id_flag field indicates whether a target_original_network_id is to be used to determine a target service instead of the original_network_id field.

A service_id_flag field indicates whether target_service_id is to be used to determine a target service instead of service_id.

Meanwhile, an extended_link_type field may indicate the link type of a target service. The value of this field will be described in detail hereinafter.

Stream_info_details_flag indicates whether additional information for an extended_link_type field is included. In the case in which the additional information for the extended_link_type field is included (stream_info_details_flag==1), stream information of a target service, which will be described hereinafter, may be included.

For example, in the case in which the target service is a UHD service based on the value of the extended_link_type field, information about a UHD service stream (uhd_stream_info_details( )) may be included. In the case in which the target service is a 3D service, information about a 3D service stream may be included. These will be described in detail hereinafter.

Consequently, it is possible to signal that the linked service is a UHD service and/or a 3DTV service using a linkage_type field (e.g. 0x0E or 0x0F) in linkage_descriptor and link type in link information included depending on the value of the linkage_type field

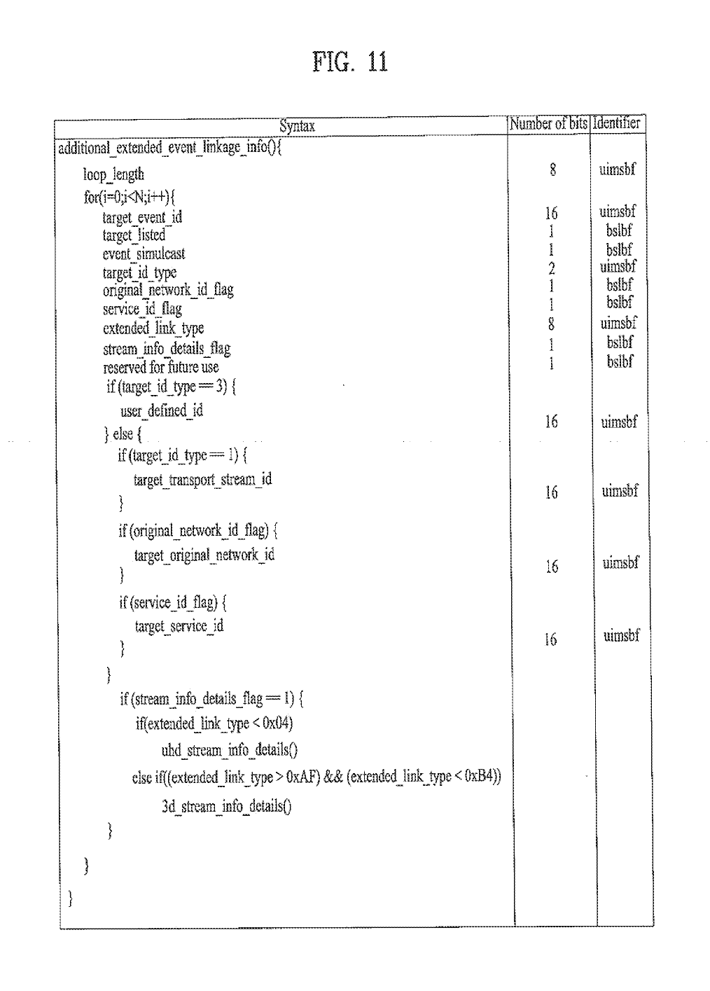

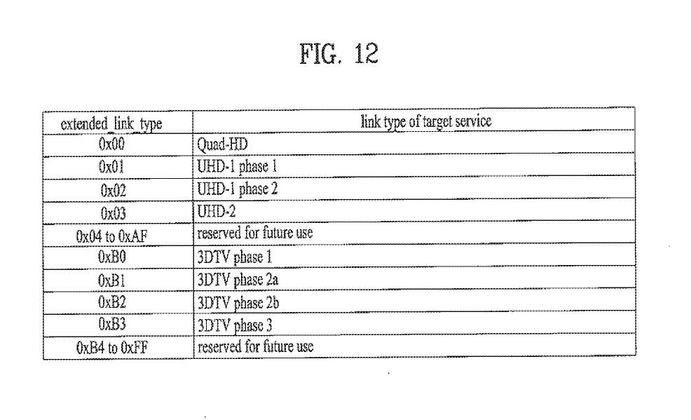

FIG. 12 is a view illustrating a link type of the target service according to the embodiment of the present invention. Depending on the value of the extended_link_type field, the link type of the target service indicates UHD-1 phase 1, UHD-1 phase 2, UHD-2, 3DTV phase 1, 3DTV phase 2a, 3DTV phase 2b, and 3DTV phase 3. In this information, each phase indicates a service level phase about UHD and/or 3DTV, and may correspond to each of the standards of UHD and/or 3DTV.

In order to indicate detailed information of the target service, detailed information of a service linked in linkage_descriptor may be included. A descriptor indicating the detailed information of the linked target service is expressed as XX_stream_info_details. The name of the descriptor may be changed based on the target service.

FIG. 13 is a view illustrating detailed information of a target service of target information according to an embodiment of the present invention. In the case in which the target service is a UHD service, an example of detailed information about a UHD service stream is as follows.

In the case in which the target service is a UHD service, detailed information of the target service may include a uhd_bit_depth field, a uhd_color_space field, a uhd_chroma_sub_sampling field, a uhd_dynamic_range field, a uhd_frame_rate field, a uhd1_phase1_compatibility_flag field, a uhd_subtitle_type field, a uhd_audio_type field, and a ‘reserved for future use’ field.

The uhd_bit_depth field may indicate the category of bit depth of the target service. A detailed example of this field will be described in detail hereinafter.

The uhd_color_space field indicates the category of color gamut type of the target service. A detailed example of this field will be described in detail hereinafter.

The uhd_chroma_sub_sampling field indicates sub-sampling information of a chroma element of the target service. For example, it may be indicated whether the ratio of Y:Cb:Cr of the target service is 4:2:0, 4:2:2, or 4:4:4 based on the value of this field. If extended_link_type is 0x01 (UHD-1 phase 1), the value of this field may indicate 4:2:0

The uhd_dynamic_range field indicates the category of the dynamic range of the target service. A detailed example of this field will be described in detail hereinafter.

The uhd_frame_rate field indicates the frame rate of the target service. A detailed example of this field will be described in detail hereinafter.

The uhd1_phase1_compatibility_flag field indicates whether the target service, which is UHD, is compatible with a conventional service. One bit may be assigned for this field.

The uhd_subtitle_type field may indicate the category of the audio type of the target service. For example, if three bits are assigned to this field, 000 may indicate that the audio of the target service has 5.1 channels, 001 may indicate that the audio of the target service has more than 5.1 channels, and 010 may indicate that the audio of the target service has object based channels. That is, the audio types of the target service may be designated using the field values.

The uhd_audio_type field may indicate the category of the subtitle type of the target service. For example, if four bits are assigned to this field, 0x0 may indicate that the subtitle type of the target service is an EBU teletext subtitle, 0x1 may indicate that the subtitle type of the target service is a DVB subtitle, 0x2 may indicate that the subtitle type of the target service is an xml format subtitle, and 0x3 may indicate that the subtitle type of the target service is a closed caption.

The above fields are illustrative fields, and therefore it is not necessary to include all of the fields. Only fields that can indicate the target service using the link information may be included.

FIG. 14 is a view illustrating detailed information of a target service of link information according to an embodiment of the present invention. In the case in which the target service is a 3DTV service, an example of detailed information about a 3DTV service stream is as follows.

A 3d_codec_type field may indicate the 3D codec type of the target service. A detailed example of this field will be described in detail hereinafter.

A 3d_format field may indicate the category of the 3D format of the target service. A detailed example of this field will be described in detail hereinafter.

A 3d_subtitle_type field may indicate the 3D subtitle format of the target service, and a 3d_audio field may indicate the 3D audio type of the target service.

A ‘reserved for future use’ field indicates an unused field.

The above fields are illustrative fields, and therefore it is not necessary to include all of the fields. Only fields that can indicate the target service using the link information may be included.

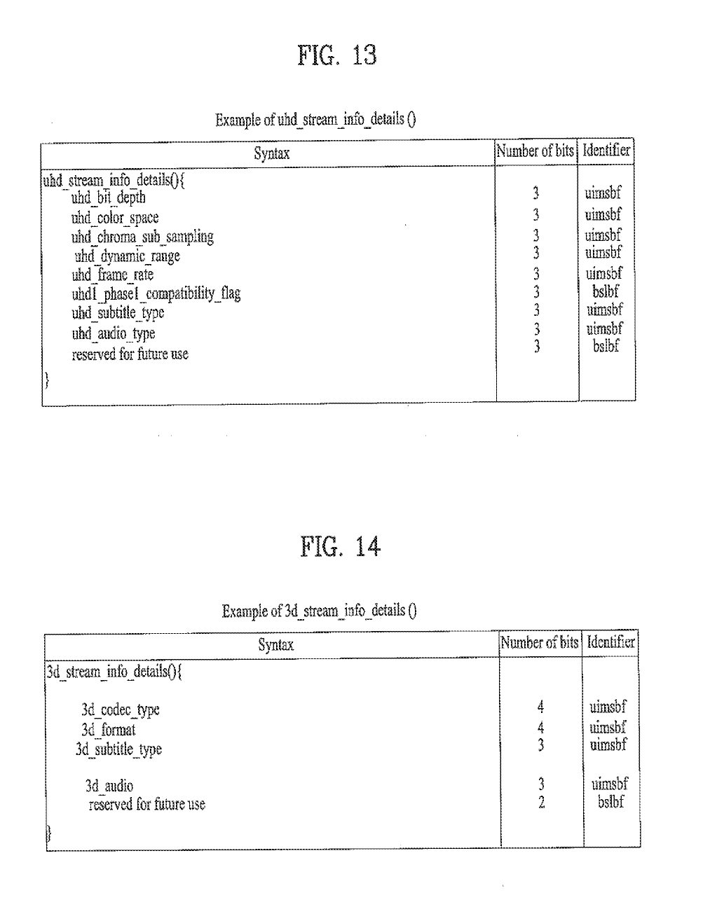

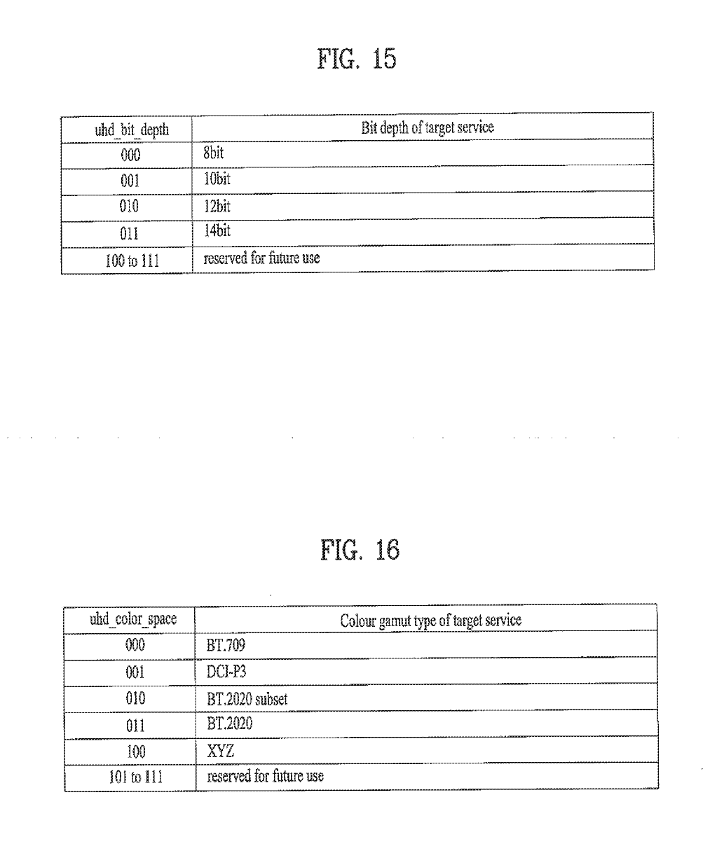

FIG. 15 is a view illustrating bit depth information included in the detailed information of the target service of the link information according to the embodiment of the present invention.

The bit depth information included in the detailed information of the target service may indicate that the bit depth of a UHD video may be 8, 10, 12, or 14 bits. A ‘reserved for future use’ field indicates an unused field.

For example, in the case in which extended_link_type is 0x01 (UHD-1 phase 1), this value may designate 001. In this case, the bit depth of the target service may be 10 bits.

FIG. 16 is a view illustrating color space information included in the detailed information of the target service of the link information according to the embodiment of the present invention.

The color space information included in the detailed information of the target service of the link information may indicate the color gamut type of the target service as illustrated. The illustrated color gamut type may be BT.709, DCI-P3, BT.2020 subset, BT.2020, or XYZ. A ‘reserved for future use’ field indicates an unused field. For example, in the case in which extended_link_type is 0x01 (UHD-1 phase 1), the value of uhd_color_space may be 000 (BT.709).

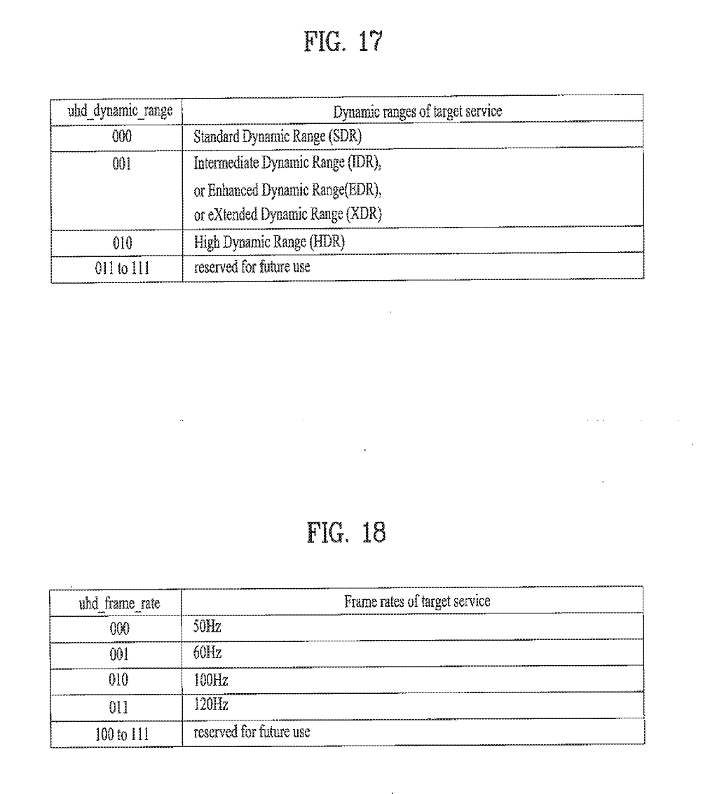

FIG. 17 is a view illustrating the dynamic range information included in the detailed information of the target service of the link information according to the embodiment of the present invention.

As illustrated, the dynamic range information included in the detailed information of the target service of the link information may designate Standard Dynamic Range (SDR) based on the value of uhd_dynamic_range. Alternatively, the dynamic range information may designate an Intermediate Dynamic Range (IDR), an Enhanced Dynamic Range (EDR), or an eXtended Dynamic Range (XDR) based on the value of uhd_dynamic_range. Alternatively, the dynamic range information may designate a High Dynamic Range (HDR) based on the value of uhd_dynamic_range. For example, in the case in which extended_link_type is 0x01 (UHD-1 phase 1), the value of uhd_dynamic_range may indicate 000 (SDR).

FIG. 18 is a view illustrating frame rate information included in the detailed information of the target service of the link information according to the embodiment of the present invention.

The frame rate information of the target service may indicate 50 Hz, 60 Hz, 100 Hz, or 120 Hz based on the value of the uhd_frame_rate field, as illustrated. For example, in the case in which extended_link_type is 0x01 (UHD-1 phase 1), the value of the uhd_frame_rate field may be 000 (50 HZ).

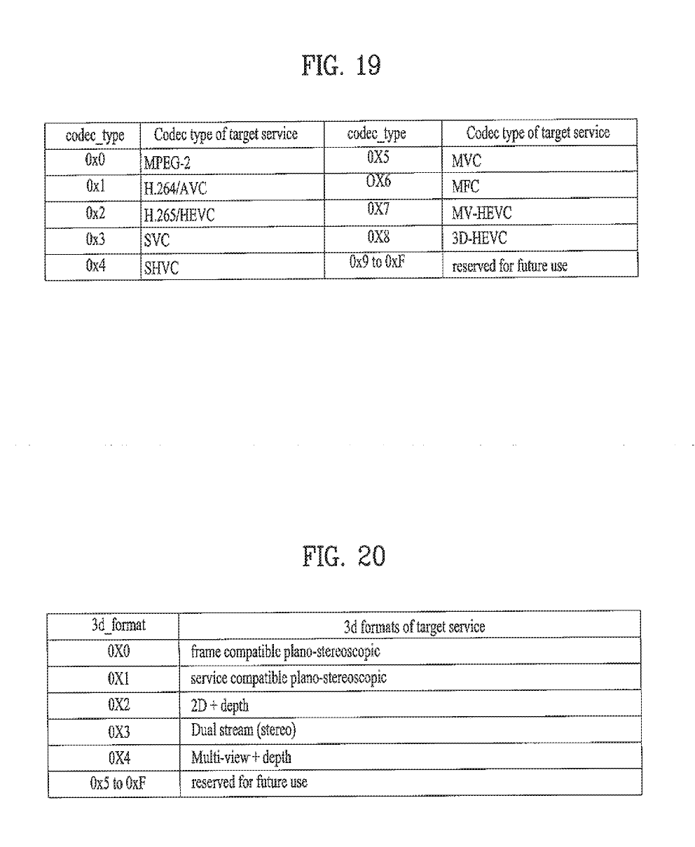

FIG. 19 is a view illustrating codec information included in the detailed information of the target service of the link information according to the embodiment of the present invention.

The codec information of the target service may indicate one of several video codecs based on the value of the 3d_codec_type field, as illustrated. In the case in which the value of the 3d_codec_type field is 0x0, it may indicate that the codec is MPEG-2. In the case in which the value of the 3d_codec_type field is 0x1, it may indicate that the codec is H.264/AVC. In the case in which the value of the 3d_codec_type field is 0x2, it may indicate that the codec is H.265/HEVC. In the case in which the value of the 3d_codec_type field is 0x3, it may indicate that the codec is SVC. In the case in which the value of the 3d_codec_type field is 0x4, it may indicate that the codec is SHVC. In the case in which the value of the 3d_codec_type field is 0x5, it may indicate that the codec is MVC. In the case in which the value of the 3d_codec_type field is 0x6, it may indicate that the codec is MFC. In the case in which the value of the 3d_codec_type field is 0x7, it may indicate that the codec is MV-HEVC. In the case in which the value of the 3d_codec_type field is 0x8, it may indicate that the codec is 3D-HEVC. The matching between the field value and the codec is illustrated, and may be changed.

FIG. 20 is a view illustrating 3D format information included in the detailed information of the target service of the link information according to the embodiment of the present invention. The 3D format information of the target service of the link information may indicate based on the value of the 3d_format field that the 3D format is a frame compatible plano-stereoscopic service, a service compatible piano-stereoscopic service, a 3D service (2D+depth) based on a 2D service and depth information, a 3D service (dual stream (stereo)) based on a dual stream, and a 3D service (multi-view+depth) based on a multi-view and depth information.

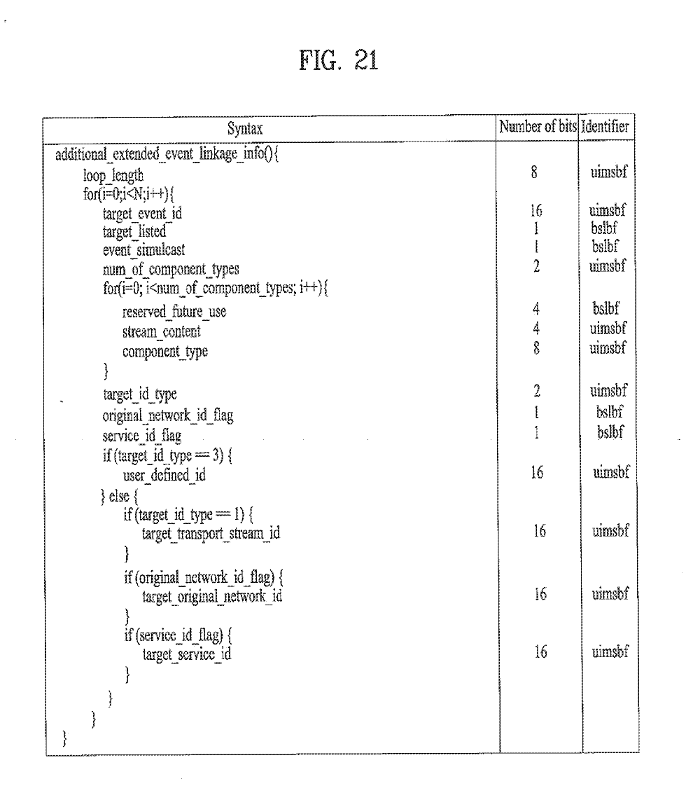

FIG. 21 is a view illustrating another example of the link information of the target service according to the embodiment of the present invention.

According to this embodiment, the link information of the target service may include link information illustrated based on the value of the linkage_type field in linkage_descriptor included in an EIT.

A target_event_id field, a target_listed field, an event_simulcast field, a target_id_type field, original_network_id_flag, and service_id_flag illustrated in this figure are the same as what have been illustrated above.

A num_of component_types field indicates the number of target event component types. If the target service includes two kinds of components, such as video and audio, two stream_content fields and two component_type fields corresponding to the respective service components may be included.

Each stream_content field may indicate the type, such as video, audio, or EBU-data, of content transmitted by a stream. Each component_type field may indicate the type, such as video, audio, or EBU-data, of a component.

According to this embodiment, even in the case in which the target service includes several service components, link information may be provided in order to identify and link all of the service components.

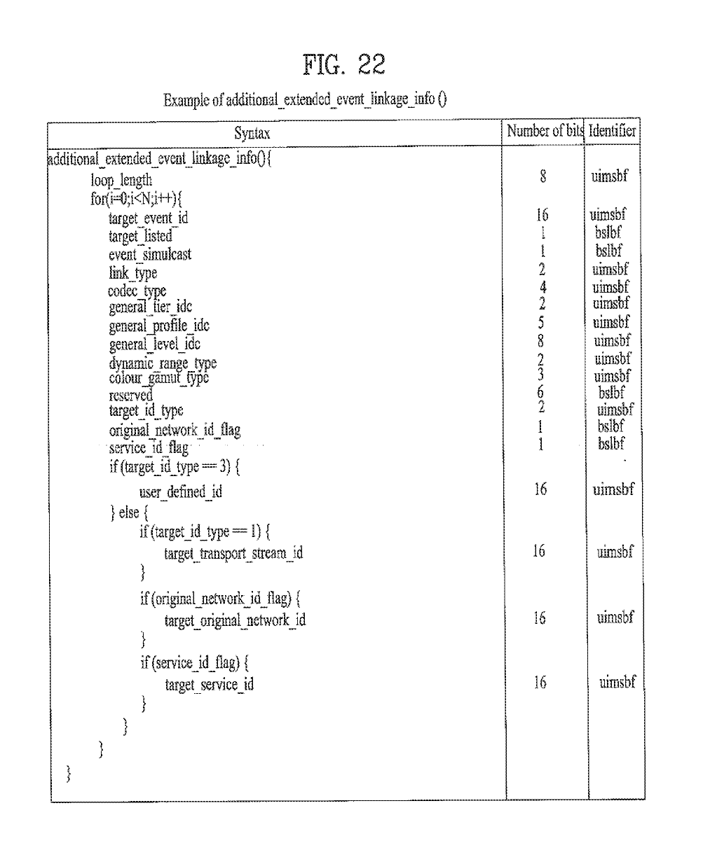

FIG. 22 is a view illustrating a further example of the link information of the target service according to the embodiment of the present invention. According to this embodiment, the link information may include a link_type field, a codec_type field, a general_tier_idc field, a general_profile_idc field, a general_level_idc field, a dynamic_range_type field, and a colour_gamut_type field.

The link_type field indicates a new type of target service. In the case in which the value of the linkage_type field is 0x0E or 0X0F (indicating additional link information for the target service), the link_type field has a value different from the value of link_type of the linkage_descriptor field. A detailed example of this field will be described in detail hereinafter.

The codec_type field indicates the codec type of the target service. A detailed example of this field will be described in detail hereinafter.

The general_tier_idc field indicates the tier of the codec of the target service. For example, in the case in which the codec does not have tiers, like H.264/AVC, the specific value of this field may be set to 0. A detailed example of this field will be described in detail hereinafter.

The general_profile_idc field indicates the level of the codec. For example, the level of the codec designated in standards, such as ITU-T Recommendation H.265|ISO/IEC 23008-2:2013, may be indicated so as to describe the target service.

The dynamic_range_type field indicates the category of the dynamic range, and the colour_gamut_type field indicates the category of the color gamut type. A detailed example of this field will be described in detail hereinafter.

The colour_gamut_type field indicates the category of the color gamut of the target service. In this example, the colour_gamut_type field indicates that the target service is a single color gamut, such as BT.709, DCI-P3, BT.2020 subset, BT.2020, or XYZ. A detailed example of this field will be described in detail hereinafter.

Other fields have already been described when describing the link information according to the previous embodiment.

According to this embodiment, it is possible to describe in detail the target service using the link information. Even in the case in which the specifications of the receiver differ, a service that can be decoded and displayed by the receiver may be connected.

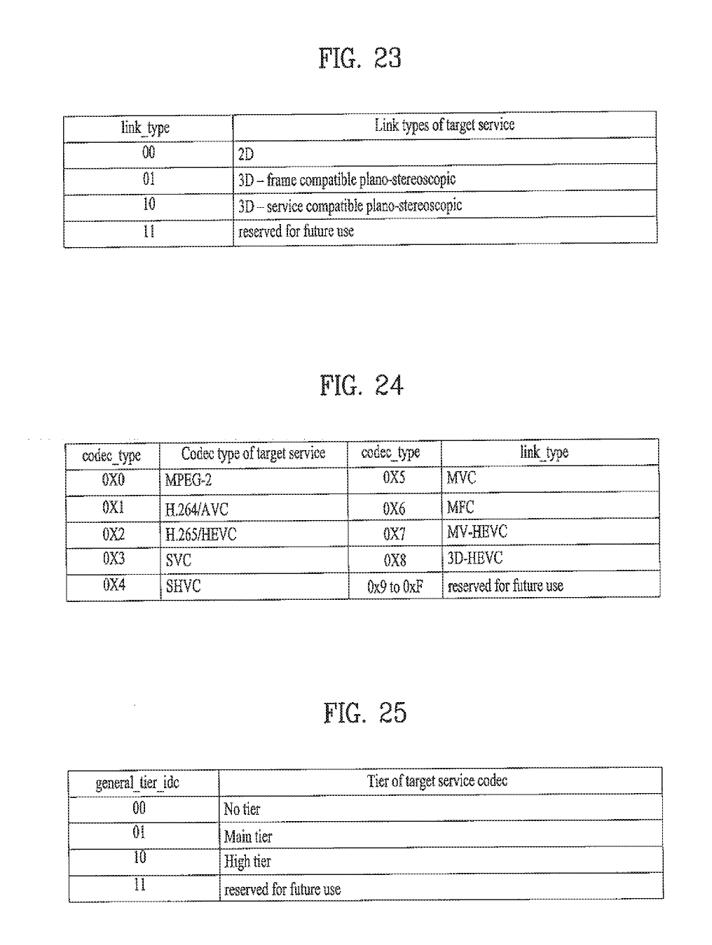

FIG. 23 is a view illustrating information about the target service type of the link information of the target service according to the embodiment of the present invention.

The link_type field, which is target service type information of the link information of the target service, indicates a new type of target service that can be linked depending on the value of the field. As previously described, when the value of the linkage_type field is 0x0E or 0X0F (indicating additional link information for the target service), the link_type field illustrated in this figure has a value different from the value of link_type of the linkage_descriptor field. According to the scheme illustrated herein, it may be indicated whether the target service is a 2D service or a 3D service depending on the value of the linkage_type field (e.g. 0x0E or 0X0F) and the value of the link_type field. In the case in which the target service is a 3D service, a frame compatible piano-stereoscopic service or a service compatible piano-stereoscopic service may be identified.

FIG. 24 is a view illustrating codec type information of the link information of the target service according to the embodiment of the present invention. The codec_type field indicates codec type of the target service. This figure illustrates the codec type of the target service based on the value of the codec_type field. For example, codec_type may be MPEG-2, H.264/AVC, H.265/HEVC, SVC, SHVC, MVC, MFC, MV-HEVC, or 3D-HEVC. The matching between the field value and the codec is illustrated, and may be changed.

FIG. 25 is a view illustrating tier information of a target service codec of the link information of the target service according to the embodiment of the present invention. The general_tier_idc field indicates the tier of the target service codec. For example, in the case in which the codec does not have tiers, like H.264/AVC, the specific value of this field may be set to 0. The general_tier_idc field may indicate tier information, such as No tier, Main tier, or High tier.

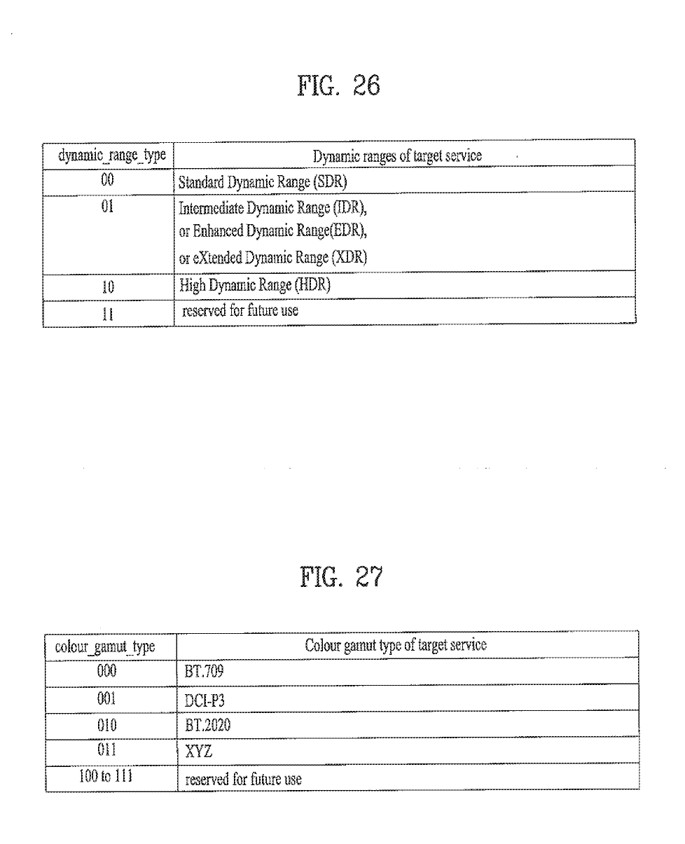

FIG. 26 is a view illustrating dynamic range information of the link information of the target service according to the embodiment of the present invention. The dynamic_range_type field may indicate a Standard Dynamic Range (SDR) or a High Dynamic Range (HDR). Alternatively, the dynamic_range_type field may indicate dynamic range information, such as an Intermediate Dynamic Range (IDR), an Enhanced Dynamic Range (EDR), or an eXtended Dynamic Range (XDR).

FIG. 27 is a view illustrating color gamut information of the target service of the link information of the target service according to the embodiment of the present invention. The colour_gamut_type field indicates the category of the color gamut of the target service. In this example, the colour_gamut_type field indicates that the target service is expressible by one color gamut, such as BT.709, DCI-P3, BT.2020 subset, BT.2020, or XYZ.

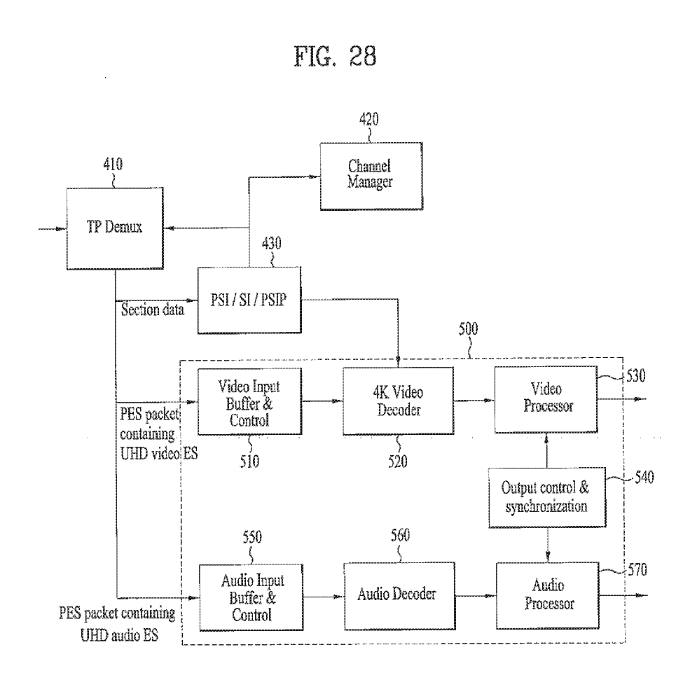

FIG. 28 is a view illustrating a signal receiving apparatus according to an embodiment of the present invention.

The signal receiving apparatus according to the embodiment of the present invention may include a demultiplexing unit 410, a signaling information decoding unit 430, and a resource decoding unit 500. The signal receiving apparatus according to the embodiment of the present invention may selectively include a channel manager 420.

The demultiplexing unit 410 may demultiplex a broadcast stream to demultiplex signaling information, a video stream, and an audio stream.

The signaling information decoding unit 430 may decode signaling information, such as section data.

The resource decoding unit 500 may include a video buffer 510, a video decoder 520, a video processor 530, a synchronization unit 540, an audio buffer 550, an audio decoder 560, and an audio processor 570.

Hereinafter, embodiments in which the signaling information decoding unit 430 identifies a UHD service will hereinafter be described.

First, in an embodiment of the present invention, it is possible to identify a UHD service using the SDT illustrated in FIG. 3.

The signaling information decoding unit 430 may identify that a UHD service is provided by the corresponding channel using a service descriptor contained in the SDT. In addition, in the case in which component_descriptor is present, the signaling information decoding unit 430 may identify information about a codec type, resolution, chroma sampling, and bit depth of the video included to provide the UHD service.

In the case in which the signaling information decoding unit 430 decodes information contained in component_descriptor, the signaling information decoding unit 430 may determine whether a video stream or an audio stream provided by the corresponding UHD service can be decoded using an embodiment of the signal receiving apparatus or the resource decoder 500.

The signaling information decoding unit 430 may obtain a PID value for acquiring the video stream and the audio stream included in the corresponding service from the PMT using component_tag specified in component_descriptor. In addition, the signaling information decoding unit 430 may transmit a corresponding PID stream to the video decoder and the audio decoder using the PID value identified in the PMT such that the corresponding PID stream can be decoded.

According to another embodiment of the present invention, it is possible to identify a UHD service using the EIT as previously illustrated.

The signaling information decoding unit 430 identifies information about an event that provides a UHD broadcast service using component_descriptor contained in the EIT illustrated in FIGS. 4 and 5.

The signaling information decoding unit 430 may identify video specification information and audio specification information that identify each event contained in component_descriptor and identify whether an embodiment of the signal receiving apparatus or the resource decoder 500 can decode the corresponding event based thereupon.

The signaling information decoding unit 430 may identify a component_tag value for each stream of component_descriptor and identify a stream matching with the component_tag value using stream_identifier_descriptor of the PMT.

The signaling information decoding unit 430 may identify a PID stream matching component_tag using the PMT at the time when the corresponding event is actually broadcast and the resource decoder 500 may decode a video stream and an audio stream having the identified PID value.

According to another embodiment of the present invention, it is possible to identify a UHD service using linkage_descriptor as previously illustrated.

An embodiment of the signal receiving apparatus displays an HD event. In the case in which a linkage descriptor for the corresponding event illustrated in FIGS. 6 and 7 is present, the signaling information decoding unit 430 may parse a linkage descriptor.

In the case in which a linkage_type field value in the linkage descriptor is, for example, 0x0E or 0x0F, the signaling information decoding unit 430 may identify a UHD broadcast and/or 3DTV event or service linked to the HD event. The signaling information decoding unit 430 may decode information (advanced_event_linkage_info ( ) in the illustrated embodiment) that is capable of identifying the linked UHD broadcast event or service in detail.

The signaling information decoding unit 430 may decode detailed information that is capable of receiving information about the linked UHD video and/or 3DTV service broadcast event using information in target service description information (advanced_event_linkage_info ( )).

An embodiment of the signal receiving apparatus may inform a user that a UM broadcast service corresponding to the HD event which the user is currently viewing is provided using the corresponding information. In the case in which the user selects a UHD broadcast service receiving signal, the signal receiving apparatus may receive and display the UHD broadcast service using information in the target service description information (advanced_event_linkage_info ( )).

The signaling information decoding unit 430 may decode the link information of the target illustrated in FIGS. 11, 21, and 22 as the link information of the target service. The signaling information decoding unit 430 may decode information included in the link information according to each embodiment in order to describe whether the target service is a linkable service.

For example, the signaling information includes service description information describing a service, and the service description information includes a first descriptor having service type information determining a service type. In the case in which the service type has a first coding value, the first coding value indicates that the service is an HEVC digital television service.

The service information may include information about an event related to the service. The event information or the service description information includes a second descriptor, and the second descriptor may include video feature information of the UHD video service data.

The video feature information may include video codec information and frame rate information of the UHD video service data.

The event information includes a third descriptor, and the third descriptor includes information indicating the type of the target service. The third descriptor may indicate whether the service linked to the event is a simulcast service or a time-off service.

The resource decoder 500 may include a video buffer 510, a video decoder 520, a video processor 530, a synchronization unit 540, an audio buffer 550, an audio decoder 560, and an audio processor 570.

The video stream demultiplexed by the demultiplexing unit 410 may be input to the video buffer 510. In this example, the video stream may be a PES packet including a UHD video elementary stream. The video buffer 510 may temporarily store video data of the input video stream.

The video decoder 520 may receive the video data stored in the video buffer 510 on a predetermined unit basis and perform video decoding. In this example, the decoder decodes 4K video data. In addition, the decoder may also output 8K or 16K video data.

For example, the video decoder 520 may decode the corresponding video data according to the features of the video data based on the decoded signaling information.

The video processor 530 may perform post-processing for the decoded video data. As a result, the video processor 530 may adjust the decoded video data such that the decoded video data can be naturally displayed.

Meanwhile, the audio stream demultiplexed by the demultiplexing unit 410 may be input to the audio buffer 550. In this example, the audio stream may be a PES packet including a UHD audio elementary stream. The audio buffer 510 may temporarily store the input audio data.

The audio decoder 560 may receive the audio data stored in the audio buffer 510 on a predetermined unit basis and perform audio decoding. The audio processor 570 may perform post-processing for the decoded audio data.

The synchronization unit 540 may synchronize and output the two types of the decoded data such that the data output by the video processor 530 and the audio processor 570 can be displayed on the same screen.

Another embodiment of the present invention may selectively include a channel manager 420. The channel manager 420 may control information necessary for channel switching based on the signaling information decoded by the signaling information decoding unit 430. For example, when the user transmits a channel switching signal, the channel manager 420 may receive the channel switching signal and perform control so as to perform channel switching. Alternatively, the channel manager 420 may determine whether it is possible to receive a specific channel using the signaling information or create a channel list and perform an operation related to channels.

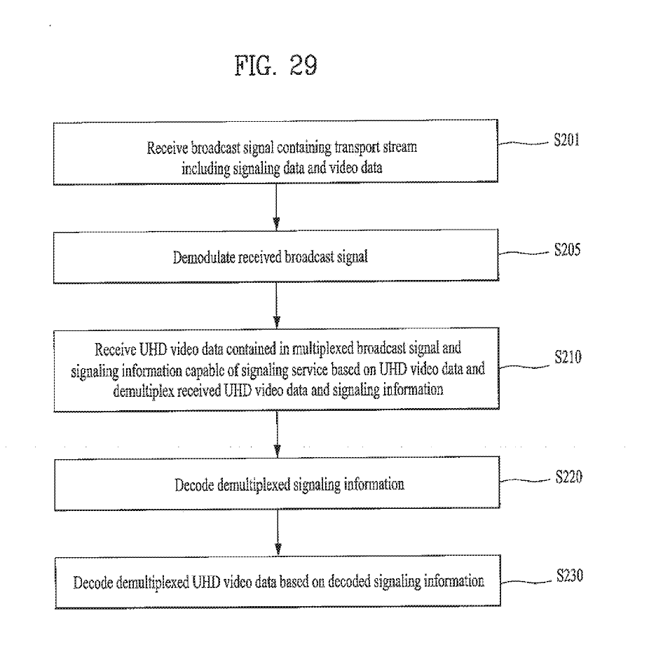

FIG. 29 is a view illustrating a signal receiving method according to an embodiment of the present invention.

A broadcast signal containing a transport stream including signaling data and video data is received (S201).

The received broadcast signal is demodulated (S205).

UHD video and/or 3DTV service data contained in the broadcast signal and signaling information that is capable of signaling a service based on the UHD video and/or 3DTV service data are received, and the received UHD video and/or 3DTV service data and signaling information are demultiplexed (S210).

The multiplexed broadcast signal may contain a subtitle stream for a UHD service. The subtitle stream may contain information about the subtitle stream for the UHD video and/or 3DTV service. Information that identifies the subtitle stream for the UHD video and/or 3DTV service, among the demultiplexed signaling information, has been previously described with reference to FIGS. 8 and 9.

The demultiplexed signaling information is decoded (S220). The demultiplexed signaling information has been previously described with reference to FIGS. 3, 4, 5, 6, 7, 11, 21, and 22. For example, it is possible to identify a UHD video service contained in the video data using the SDT, the EIT or linkage_descriptor (linkage_type and link_type) contained in the EIT. Signaling may be performed for the target service to identify the UHD video and/or 3DTV service using the signaling information.

The demultiplexed UHD video data are decoded based on the decoded signaling information (S230). The UHD video data may be decoded.

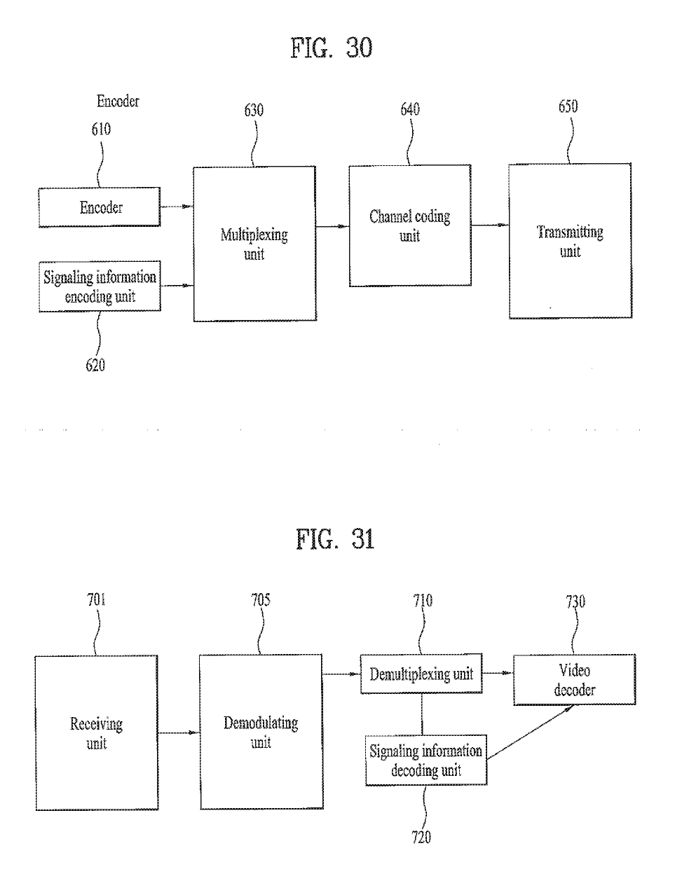

FIG. 30 is a view illustrating a signal transmitting apparatus according to an embodiment of the present invention.

An encoder 610 encodes UHD video data. For example, the encoded UHD video data may have a resolution of 4K, 8K, or 16K.

A signaling information encoding unit 620 encodes a UHD broadcast service based on the UHD video data and information that is capable of being signaled with the features of the encoded UHD video data. Examples of signaling a UHD video service have been previously described with reference to FIGS. 3, 4, 5, 6, 7, 11, 21, and 22. The features of the encoded UHD video data are illustrated in FIG. 5. The signaling information may include link information for linking the target service.

For example, the signaling information may include service description information describing a service, and the service description information may include a first descriptor having service type information determining a service type. When the service type has a first coding value, the first coding value may indicate that the service is an HEVC digital television service.

The service information may include information about an event related to the service. The event information or the service description information includes a second descriptor, and the second descriptor may include video feature information of the UHD video and/or 3DTV service data.

The video feature information may include video codec information and frame rate information of the UHD video and/or 3DTV service data.

The event information includes a third descriptor, and the third descriptor includes information indicating the type of the target service. The third descriptor may indicate whether the service linked to the event is a simulcast service or a time-off service.

The type of the target service may indicate that the target service is a UHD service based on the UHD video service data. The event information may include a third descriptor, and the third descriptor may include information indicating a link type.

A multiplexing unit 630 multiplexes and transmits the encoded UHD video data and signaling information. The multiplexed broadcast signal may contain a subtitle stream for a UHD service.

The subtitle stream may contain information about the subtitle stream for the UHD service. Information that identifies the subtitle stream for the UHD service, among the demultiplexed signaling information, has been previously described with reference to FIGS. 8 and 9.

The multiplexed subtitle stream may contain information about the corresponding subtitle. For example, in the case in which, for a UHD service having a size of 3840×2160, the size of a subtitle has a HD resolution (1920×1080), parameters that define a window for the subtitle may be defined as follows in the subtitle stream.

The position of the leftmost pixel of the subtitle that is relatively positioned at the leftmost pixel of the display (display_window_horizontal_position_minimum) may be defined as 960.

The position of the rightmost pixel of the subtitle that is relatively positioned at the rightmost pixel of the display (display_window_horizontal_position_minimum) may be defined as 2879.

The position of the uppermost pixel of the subtitle that is relatively positioned at the uppermost pixel of the display (display_window_vertical_position_minimum) may be defined as 540.

The position of the lowermost pixel of the subtitle that is relatively positioned at the lowermost pixel of the display (display_window_vertical_position_maximum) may be defined as 1619. These values may be changed depending upon the resolution of the UHD service.

That is, the parameters may have window position values for the subtitle depending on the UHD service.

A channel coding unit 640 may channel-code a transport stream.

A transmitting unit 650 may modulate the transport stream, and may transmit the modulated transport stream.

FIG. 31 is a view illustrating a signal receiving apparatus according to another embodiment of the present invention.

A receiving unit 701 receives a broadcast signal containing a transport stream including signaling data and video data.

A demodulating unit 705 demodulates the received broadcast signal.

A demultiplexing unit 710 receives UHD video data contained in a multiplexed broadcast signal and signaling information that is capable of signaling a service based on the UHD video data and demultiplexes the received UHD video data and signaling information. For example, the demultiplexing unit 710 is the same as that illustrated in FIG. 28.

The multiplexed broadcast signal may contain a subtitle stream for a UHD service. The subtitle stream may contain information about the subtitle stream for the UHD service. Information that identifies the subtitle stream for the UHD service, among the demultiplexed signaling information, has been previously described with reference to FIGS. 8 and 9.

A signaling information decoding unit 720 decodes the demultiplexed signaling information. The demultiplexed signaling information has been previously described with reference to FIGS. 3, 4, 5, 6, 7, 11, 21, and 22. For example, it is possible to identify a UHD video and/or 3DTV service contained in the video data using SDT, EIT or linkage_descriptor contained in EIT. The demultiplexed signaling information may include information about the subtitle stream for the UHD video and/or 3DTV service, which has been previously described with reference to FIGS. 8 and 9. The demultiplexed signaling information may include link information for linking the target service.

For example, the signaling information may include service description information describing a service, and the service description information may include a first descriptor having service type information determining a service type. When the service type has a first coding value, the first coding value may indicate that the service is an HEVC digital television service.

The service information may include information about an event related to the service. The event information or the service description information may include a second descriptor, and the second descriptor may include video feature information of the UHD video and/or 3DTV service data.

The video feature information may include video codec information and frame rate information of the UHD video service data.

The event information includes a third descriptor, and the third descriptor includes information indicating the type of the target service. The third descriptor may indicate whether the service linked to the event is a simulcast service or a time-off service.

The type of the target service may indicate that the target service is a UHD video and/or 3DTV service based on the UHD video and/or 3DTV service data. The type of the target service may indicate that the target service is a UHD video and/or 3DTV service based on the UHD video and/or 3DTV service data. The event information includes a third descriptor, and the third descriptor includes information indicating a link type. In the embodiment of the present invention, therefore, it is possible to identify a UHD video and/or 3DTV service, which is the target service, using a combination of linkage_type and link_type based on the link information.

For example, the signaling information decoding unit 720 is the same as illustrated in FIG. 28.

A video decoder 730 decodes the demultiplexed UHD video data based on the decoded signaling information. The video decoder 730 may decode subtitle data contained in the subtitle stream for the UHD service. The video decoder 730 may be the same as illustrated in FIG. 10.

According to the illustrated embodiment, it is possible to signal that a target service is a UHD service and/or a 3DTV service and to transceive link information of the UHD service and the 3DTV service such that a receiver performs switching between the UHD service and the 3DTV service, which are identified.

### MODE FOR INVENTION

Various embodiments for carrying out the invention have been described in the best mode for carrying out the invention.

### INDUSTRIAL APPLICABILITY

The present invention has industrial applicability in that the present invention can be repeatedly used in broadcast and video signal processing fields.

1. A signal transmitting method comprising:
encoding video service data (S110), wherein the video service data comprises UHD video service data;
generating signaling information, wherein the signaling information comprises service description information describing a service, the service description information comprises service type information determining a type of the service, the service type information indicates that the service is an HEVC digital television service, the service information comprises information about an event related to the service, the event information or the service description information comprises video characteristic information of the UHD video service data, and the video characteristic information comprises video codec information and frame rate information of the UHD video service data;
multiplexing the signaling information and the UHD video data into a transport stream (S130);
channel-coding the transport stream (S140); and
modulating the transport stream and transmitting the modulated stream (S150).

2. The signal transmitting method according to claim 1, wherein the event information comprises information indicating a type of a target service and information indicating whether the service linked to the event is a simulcast service or a time-off service.

3. The signal transmitting method according to claim 2, wherein the type of the target service indicates that the target service is a UHD service based on the UHD video service data.

4. The signal transmitting method according to claim 1, wherein the event information comprises link information of a target service, and the link information indicates that the target service is a UHD service and/or a 3DTV service.

5. A signal receiving method comprising:
receiving a broadcast signal containing a transport stream (S210);
demodulating the broadcast signal;
demultiplexing the transport stream from the demodulated broadcast signal into signaling information and video service data, wherein the signaling information comprises service description information describing a service, the service description information comprises service type information determining a type of the service, the service type information indicates that the service is an HEVC digital television service, the service information comprises information about an event related to the service, the event information or the service description information comprises video characteristic information of the UHD video service data, and the video characteristic information comprises video codec information and frame rate information of the UHD video service data;
decoding the signaling information; and
decoding the video service data based on the decoded signaling information.

6. The signal receiving method according to claim 5, wherein the event information comprises information indicating a type of a target service and information indicating whether the service linked to the event is a simulcast service or a time-off service.

7. The signal receiving method according to claim 6, wherein the type of the target service indicates that the target service is a UHD service based on the UHD video service data.

8. The signal receiving method according to claim 5, wherein the event information comprises link information of a target service, and the link information indicates that the target service is a UHD service and/or a 3DTV service.

9. A signal transmitting apparatus comprising:
an encoder (610) for encoding video service data, wherein the video service data comprises UHD video service data;
a signaling information encoding unit (620) for generating signaling information, wherein the signaling information comprises service description information describing a service, the service description information comprises service type information determining a type of the service, the service type information indicates that the service is an HEVC digital television service, the service information comprises information about an event related to the service, the event information or the service description information comprises video characteristic information of the UHD video service data, and the video characteristic information comprises video codec information and frame rate information of the UHD video service data;
a multiplexing unit (630) for multiplexing the signaling information and the UHD video data into a transport stream;
a channel coding unit (640) for channel-coding the transport stream; and
a transmitting unit (650) for modulating the transport stream and transmitting the modulated stream.

10. The signal transmitting apparatus according to claim 9, wherein the event information comprises information indicating a type of a target service and information indicating whether the service linked to the event is a simulcast service or a time-off service.

11. The signal transmitting apparatus according to claim 10, wherein the type of the target service indicates that the target service is a UHD service based on the UHD video service data.

12. The signal transmitting apparatus according to claim 9, wherein the event information comprises link information of a target service, and the link information indicates that the target service is a UHD service and/or a 3DTV service.

13. A signal receiving apparatus comprising:
a receiving unit (701) for receiving a broadcast signal containing a transport stream;
a demodulating unit (705) for demodulating the broadcast signal;
a demultiplexing unit (710) for demultiplexing the transport stream from the demodulated broadcast signal into signaling information and video service data, wherein the signaling information comprises service description information describing a service, the service description information comprises service type information determining a type of the service, the service type information indicates that the service is an HEVC digital television service, the service information comprises information about an event related to the service, the event information or the service description information comprises video characteristic information of the UHD video service data, and the video characteristic information comprises video codec information and frame rate information of the UHD video service data;
a signaling information decoding unit (720) for decoding the signaling information; and
a video decoder (730) for decoding the video service data based on the decoded signaling information.

14. The signal receiving apparatus according to claim 13, wherein the event information comprises information indicating a type of a target service and information indicating whether the service linked to the event is a simulcast service or a time-off service.

15. The signal receiving apparatus according to claim 14, wherein the type of the target service indicates that the target service is a UHD service based on the UHD video service data.
